(19) United States
(12) Patent Application Publication
(10) Pub. No.: US 2026/0036929 A1
(43) Pub. Date: Feb. 5, 2026

(54) FUSER AND IMAGE FORMING APPARATUS

(71) Applicant: BROTHER KOGYO KABUSHIKI KAISHA, Nagoya (JP)

(72) Inventors: Toshinori ARAKI, Nagoya (JP); Yoshiyuki TSUJIMOTO, Nagoya (JP)

(73) Assignee: BROTHER KOGYO KABUSHIKI KAISHA, Nagoya (JP)

(21) Appl. No.: 19/253,206

(22) Filed: Jun. 27, 2025

(30) Foreign Application Priority Data
Jul. 31, 2024 (JP) 2024-124563

(51) Int. Cl. G03G 15/20; G03G 15/00

(52) U.S. Cl. CPC G03G 15/205; G03G 15/2017; G03G 15/2064; G03G 15/80; G03G 2215/00084

(57) ABSTRACT

A fuser detachably attachable to an image forming apparatus includes a heating rotatable body to heat a sheet, a heater to heat the heating rotatable body, a pressing rotatable body to nip the sheet in cooperation with the heating rotatable body, a detection sensor to detect a status of the fuser, a fuser connector, through which the fuser is connected with the image forming apparatus when the fuser is attached to the image forming apparatus and which includes a fuser common terminal, and a relay board including a common terminal connected to the fuser common terminal, and a memory. The relay board is connected with the detection sensor and is configured to relay a detection signal from the detection sensor to the image forming apparatus and a memory signal between the memory and the image forming apparatus via the common terminal and the fuser common terminal.

### REFERENCE TO RELATED APPLICATIONS

This application claims priority from Japanese Patent Application No. 2024-124563, filed on Jul. 31, 2024. The entire content of the priority application is incorporated herein by reference.

### BACKGROUND ART

Conventionally, as an image forming apparatus that may form a toner image on a sheet, a printing apparatus is known. The image forming apparatus may heat the sheet, on which the toner image is formed, to fix the image as a printed image. For heating the sheet, generally, the image forming apparatus may have a fuser, which is heated by an electric heater. However, as the fuser is used over a long time, a printing quality of the image forming apparatus including the fuser may gradually deteriorate. Therefore, the fuser may be designed to be detachably attachable to the image forming apparatus via a connector, and may be replaced periodically.

The fuser may include various types of sensors to monitor operating statuses thereof. Such sensors may include, for example, a sensor for detecting a temperature of the fuser, a sensor for detecting whether a heat roller and a pressure roller are in a mutually pressed state, and a sensor for detecting the sheet passing through the fuser. The fuser may transmit signals from the sensors to the image forming apparatus via the connector. The signals from such sensors may be, for example, once relayed by a relay board provided in the fuser, and may be transmitted to a controller in the image forming apparatus via the connector, which includes a connector on a side of the fuser and a connector on a side of the image forming apparatus side connected with each other.

### SUMMARY

Increasing the number of terminals in the connector on the side of the fuser may increase manufacturing cost and increase a size of the connector. Therefore, it is desirable to reduce the number of terminals in the connector in the fuser that is detachably attachable to the image forming apparatus. Meanwhile, in a configuration where the fuser is equipped with a memory, the fuser requires additional terminals in the connector on the side of the fuser to allow the image forming apparatus to access the memory. As such, reduction of the number of terminals in the connector on the side of the fuser has been demanded.

Aspects of the present disclosure are advantageous in providing a fuser, which includes a memory, and an image forming apparatus, where the number of terminals in a connector connecting the fuser and the image forming apparatus is reducible.

According to an aspect of the present disclosure, a fuser, detachably attachable to an image forming apparatus which is configured to form a toner image on a sheet, includes a heating rotatable body, a heater, a pressing rotatable body, a detection sensor, a fuser connector, and a relay board. The heating rotatable body is configured to heat the sheet. The heater is configured to heat the heating rotatable body. The pressing rotatable body is configured to nip the sheet in cooperation with the heating rotatable body. The detection sensor is configured to detect a status of the fuser. The fuser connector, through which the fuser is connected with the image forming apparatus when the fuser is attached to the image forming apparatus, includes a fuser common terminal. The relay board includes a common terminal, connected to the fuser common terminal, and a memory. The relay board is connected with the detection sensor and is configured to relay a detection signal from the detection sensor to the image forming apparatus and a memory signal between the memory and the image forming apparatus via the common terminal and the fuser common terminal.

According to another aspect of the present disclosure, an image forming apparatus, to which a fuser is detachably attached, is configured to form a toner image on a sheet. The fuser includes a heating rotatable body configured to heat the sheet, a heater configured to heat the heating rotatable body, a pressing rotatable body configured to nip the sheet in cooperation with the heating rotatable body, a first detection sensor configured to detect a status of the fuser, a fuser connector, through which the fuser is connected with the image forming apparatus when the fuser is attached to the image forming apparatus and include a first fuser common terminal, and a relay board including a first common terminal connected to the first fuser common terminal, and a memory. The relay board is connected with the first detection sensor and is configured to relay a first detection signal from the first detection sensor to the image forming apparatus and a first memory signal between the memory and the image forming apparatus via the first common terminal and the first fuser common terminal. The image forming apparatus includes a main-body connector connectable with the fuser connector and including a first main-body common terminal connectable with the first fuser common terminal and a control board including a controller connected with the main-body connector. The controller is configured to receive the first detection signal from the first detection sensor via the first common terminal, the first fuser common terminal, and the first main-body common terminal, and communicate with the memory to transmit and receive the first memory signal to and from the memory via the first common terminal, the first fuser common terminal, and the first main-body common terminal.

### BRIEF DESCRIPTION OF DRAWINGS

FIG. 1 is a schematic view of a printer.

FIG. 2 is an illustrative view of the printer with a rear cover being open.

FIG. 3 is an illustrative view of the printer with a fuser being removed.

FIG. 4 is a frontward perspective view showing an inner structure of the fuser.

FIG. 5 is a rearward perspective view showing the inner structure of the fuser.

FIG. 6 is an illustrative view of a pressure-contact/separation assembly.

FIG. 7 is a diagram illustrating an electrical configuration of the printer.

FIG. 8 is a diagram illustrating an electrical configuration of a relay board in the fuser.

FIG. 9 is a diagram illustrating the electrical configuration of the relay board in the fuser.

FIG. 10 is a diagram illustrating a clock signal output from an ASIC.

FIG. 11 is a flowchart illustrating a flow of steps in a printing process.

FIGS. 12A-12B are a flowchart illustrating a flow of steps in another printing process.

FIGS. 13A-13B are a flowchart illustrating a flow of steps in another printing process.

### DESCRIPTION

Hereinafter, an image forming apparatus according to first through third illustrative embodiments of the present disclosure will be described with reference to the accompanying drawings.

### First Embodiment

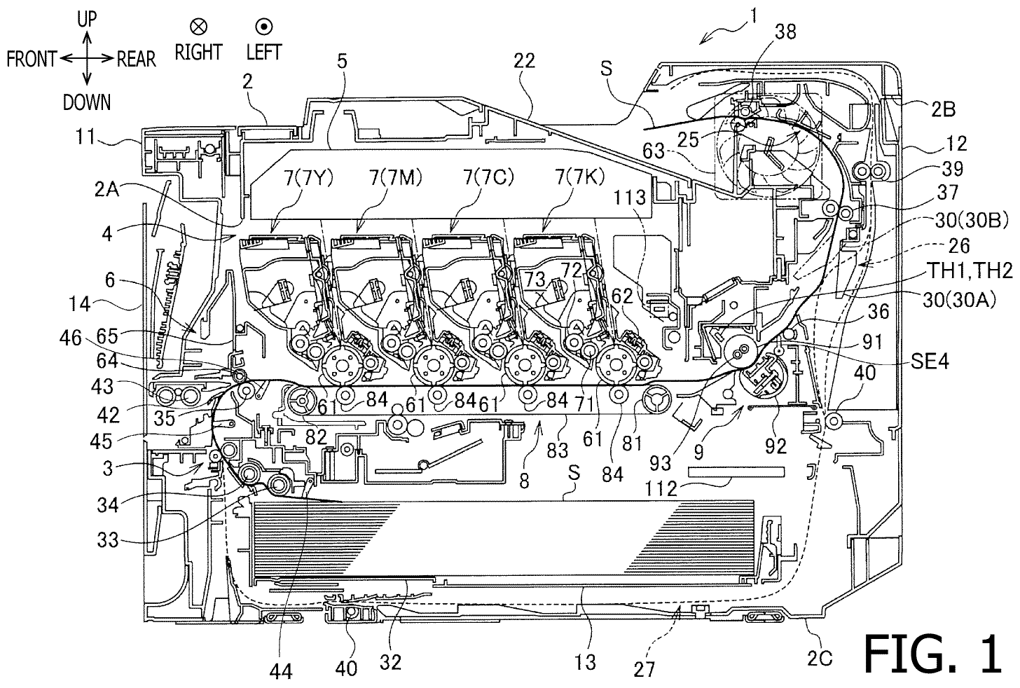

First, an overall configuration of a printer 1 according to the first embodiment will be described. FIG. 1 illustrates an overall configuration of the printer 1 according to the first embodiment. In the following description, a front-rear direction and an up-down direction are as indicated by arrows in some of the drawings.

### Overall Configuration of the Printer

The printer 1 according to the first embodiment is a color laser printer in an electrophotographic style and is configured to form a toner image on a sheet S. Optionally, the printer 1 may be a monochrome laser printer. The printer 1 includes a main body 2, a conveyer 3, a process unit 4, and a fuser 9 which is detachably attached to the main body 2.

The main body 2 includes a front cover 11, a rear cover 12, a feeder tray 13, a discharge tray 22, a first conveyer path 25, a second conveyer path 26, and a third conveyer path 27. The front cover 11 is a cover that may open or close a front opening 2A formed at a front part of the main body 2 and is attached to a front face of the main body 2 in an openable/closable structure. The rear cover 12 is a cover that may open or close a rear opening 2B formed at a rear part of the main body 2 and is attached to a rear face of the in an openable/closable manner. The feeder tray 13 is detachably attached to a lower part of the main body 2. In the feeder tray 13, one or more sheets S may be placed. The sheets S may be, for example, standard-sized sheets such as A4-sized sheets. The sheets S may be, for example, but not necessarily limited to, paper media such as plain paper or thick paper, and may be, for another example, OHP films. The discharge tray 22 is located at an upper part of the main body 2, and the sheets S, on which images are formed, are placed on the discharge tray 22.

Further, a multipurpose tray 14 is formed as a part of the front cover 11, and by tilting the multipurpose tray 14 forward, one or more sheets S may be manually inserted through the multipurpose tray 14. The printer 1 may selectively print not only on the sheets S supplied from the feeder tray 13 but also on the sheets S inserted through the multipurpose tray 14.

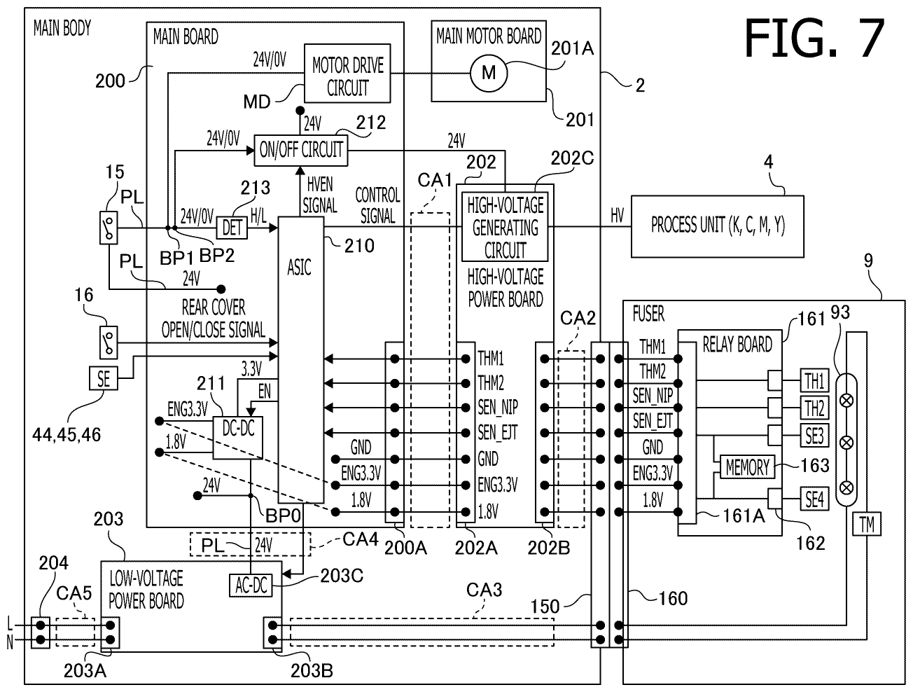

The conveyer 3 includes a pickup roller 33, a separation roller 34, a registration roller 35, a first conveyer roller 36, a second conveyer roller 37, a first switchback roller 38, a second switchback roller 39, a plurality of third conveyer rollers 40, a flapper 30, and a main motor 201A (see FIG. 7). A part of the second conveyer path 26 is formed of the rear cover 12 in a closed state.

The pickup roller 33 may pick up the sheets S from the feeder tray 13, which is pushed upward by a sheet pressing plate 32, and convey the sheets S toward the first conveyer path 25. The separation roller 34 may separate the sheets S picked up by the pickup roller 33 one by one.

Further, on a downstream side of the pickup roller 33, a sheet feed sensor 44 is disposed to detect passing of the sheet S, which was picked up from the feeder tray 13 and fed into the conveyer 3. In other words, the sheet feed sensor 44 may detect the sheet S being fed.

The registration roller 35 is disposed on an upstream side of the process unit 4 in the first conveyer path 25. The registration roller 35 may align a leading edge of the sheet S with a correct direction and thereafter convey the sheet S toward the process unit 4. Along a sheet conveying direction, the registration roller 35 conveys the sheet S from the front toward the rear. In other words, the conveying direction to the registration roller 35 to convey the sheet S is frontward.

Further, on an upstream side of the registration roller 35 in the sheet conveying direction, a pre-registration sensor 45 to detect the leading edge of the sheet S passing in the first conveyer path 25 is disposed. Moreover, on a downstream side of the registration roller 35 in the sheet conveying direction, a post-registration sensor 46 to detect the leading edge of the sheet S passing in the first conveyer path 25 is disposed. The sheet feed sensor 44, and each of the pre-registration sensor 45 and the post-registration sensor 46, includes an actuator rotatable about a rotation axis and an unshown photosensor. When the sheet S passing through the first conveyer path 25 contacts and tilts the actuator, the photosensor located near the rotation axis of the actuator detects that the actuator has tilted, i.e., that the sheet S has passed.

The pre-registration sensor 45 is used to determine a drive timing of the registration roller 35 located downstream, and the post-registration sensor 46 is used to determine a timing to execute an image forming process in the downstream process unit 4.

When the conveyer 3 conveys the sheet S outward from the main body 2 and the rear cover 12 is closed, the sheet S conveyed from the process unit 4 is conveyed by the first conveyer roller 36 and guided into the first conveyer path 25 by the flapper 30 (30A). Thereafter, the conveyer 3 conveys the sheet S guided into the first conveyer path 25 by the second conveyer roller 37 and the first switchback roller 38, and discharges the sheet S onto the discharge tray 22.

When the conveyer 3 conveys the sheet S outward from the main body 2 with the rear cover 12 being open, the sheet S conveyed from the process unit 4 is conveyed by the first conveyer roller 36, guided rearward by the flapper 30 (30B) moved to swing to a position indicated by a broken line, and discharged onto the rear cover 12 being open through the rear opening 2B. The printer 1 is capable of forming an image on the sheet S even when the rear cover 12 is open. The rear cover 12 is a cover and allows the sheet S with the image formed thereon to be discharged through a rear opening 2B when being open.

When the conveyer 3 conveys the sheet S back to the process unit 4, the sheet S conveyed from the process unit 4 is conveyed by the first conveyer roller 36 and guided by the flapper 30 to the first conveyer path 25 or the second conveyer path 26. When the sheet S is guided to the first conveyer path 25, the conveyer 3 conveys the sheet S in the first conveyer path 25 to the third conveyer path 27 with the second conveyer roller 37 and the first switchback roller 38. When the sheet S is guided to the second conveyer path 26, the conveyer 3 conveys the sheet S in the second conveyer path 26 to the third conveyer path 27 with the second switchback roller 39.

The sheet S conveyed to the third conveyer path 27 is again fed to the process unit 4 by devices or members including the third conveyer rollers 40 and the registration roller 35. Further, after the image is formed on the sheet S in the process unit 4, the sheet S is discharged by the conveyer 3 onto the discharge tray 22.

The conveyer 3 further includes a separation pad 42 and a pickup feed roller 43 for separating and conveying the sheet S manually inserted from the multipurpose tray 14. The separation pad 42 and the pickup feed roller 43 separate the sheets S inserted from the multipurpose tray 14 one by one and convey the separated sheet S toward the process unit 4. Thereafter, the sheet S may be conveyed in the same manner as the sheet S conveyed from the feeder tray 13 as described above.

The process unit 4 includes an exposure unit 5, a drum unit 6, four developing cartridges 7Y, 7M, 7C, 7K, and a transfer unit 8. The process unit 4 has a function to form a toner image on the sheet S.

The exposure unit 5 is disposed in an upper area inside the main body 2, and includes light sources, polygon mirrors, lens, and reflecting mirrors, which are not shown. The exposure unit 5 emits light beams, indicated by dash-and-dot lines, onto surfaces of photosensitive drums 61, exposing the surfaces of the photosensitive drums 61.

The drum unit 6 is disposed between the feeder tray 13 and the exposure unit 5 in the main body 2, and includes four photosensitive drums 61, four chargers 62, a pinch roller 64, and a support frame 65 that supports the members including the photosensitive drums 61. The drum unit 6 is attachable to and detachable from the main body 2 through the front opening 2A when the front cover 11 is open. The pinch roller 64 is located opposite to the registration roller 35. The pinch roller 64 rotates in response to rotation of the registration roller 35, and conveys the sheet S in cooperation with the registration roller 35.

The developing cartridges 7Y, 7M, 7C, 7K correspond to the four colors yellow (Y), magenta (M), cyan (C), and black (K), respectively, and are detachably mounted on the drum unit 6 in this given order from the front to the rear of the printer 1. Each of the developing cartridges 7Y, 7M, 7C, 7K includes a developing roller 71, a supply roller 72, and a toner container 73. While colors of toners contained in the developing cartridges 7Y, 7M, 7C, 7K differ, the configurations of the developing cartridges 7Y, 7M, 7C, 7K are the same; therefore, one of the developing cartridges 7Y, 7M, 7C, 7K may be representatively referred to as the developing cartridge 7 in the following description.

The transfer unit 8 is disposed between the feeder tray 13 and the drum unit 6 inside the main body 2, and includes a drive roller 81, a driven roller 82, a conveyer belt 83, and four transfer rollers 84. The conveyer belt 83 is strained between the drive roller 81 and the driven roller 82, and an upper surface of the conveyer belt 83 is in contact with the photosensitive drums 61. The four transfer rollers 84 are disposed on an inner side of the conveyer belt 83 so as to nip the conveyer belt 83 together with the corresponding photosensitive drums 61.

The process unit 4 uniformly charges surfaces of the photosensitive drums 61 using the chargers 62, and exposes the surfaces by the exposure unit 5, thereby forming electrostatic latent images on the surfaces of the photosensitive drums 61. The process unit 4 supplies the toner in the toner containers 73 to the supply rollers 72, and from the supply rollers 72 to the developing rollers 71. The toners supplied to the developing rollers 71 are carried on the developing rollers 71 as the developing rollers 71 rotate.

The process unit 4 forms toner images on the surfaces of the photosensitive drums 61 by supplying the toners carried on the developing rollers 71 to the electrostatic latent images formed on the photosensitive drums 61. Thereafter, the process unit 4 transfers the toner images on the photosensitive drums 61 to the sheet S by conveying the sheet S, which was fed from the feeder tray 13 by the conveyer 3, between the photosensitive drums 61 and the conveyer belt 83. As such, the process unit 4 forms a toner image on the sheet S. Subsequently, the process unit 4 conveys the sheet S to the fuser 9.

The fuser 9 is, in state attached to the printer 1, disposed rearward from the process unit 4 inside the main body 2. More specifically, the fuser 9 is disposed between the rear cover 12 being closed and the process unit 4. The fuser 9 includes a heat roller 91 for heating the sheet S and a pressure roller 92 for nipping the sheet S in cooperation with the heat roller 91. The heat roller 91 is an example of the heating rotatable body. The pressure roller 92 is an example of the pressing rotatable body. In the first embodiment, the heat roller 91 includes a heater 93 inside for heating the heat roller 91.

The fuser 9 fixes the toner image formed on the sheet S to the sheet S by conveying the sheet S between the heat roller 91 and the pressure roller 92.

Further, on a downstream side of the fuser 9 in the sheet conveying direction, a discharge sensor SE4 is disposed to detect the sheet S, which has passed through the position between the heat roller 91 and the pressure roller 92. In other words, the discharge sensor SE4 may detect passing of the sheet S, on which the developed image is fixed by the fuser 9.

The printer 1 further includes a fuser fan 63 inside the main body 2. The fuser fan 63 is configured to exhaust air from the inside of the main body 2 to the outside when driven.

Meanwhile, the fuser 9 includes two fuser temperature sensors TH1, TH2 for detecting temperatures of the heat roller 91. The fuser temperature sensors TH1, TH2 include variable resistors, of which resistance values vary depending on the temperature of an inspection area, and which are capable of outputting signals corresponding to the temperatures of the respective detection areas. The fuser temperature sensors TH1, TH2 are both disposed to face the heat roller 91 in a non-contact arrangement, and inspect different inspection regions in the heat roller 91. The fuser temperature sensor TH2 is a sensor for detecting a temperature of a region around a center of the heat roller 91. The fuser temperature sensor TH1 is a sensor for detecting a temperature of a region around an end area of the heat roller 91.

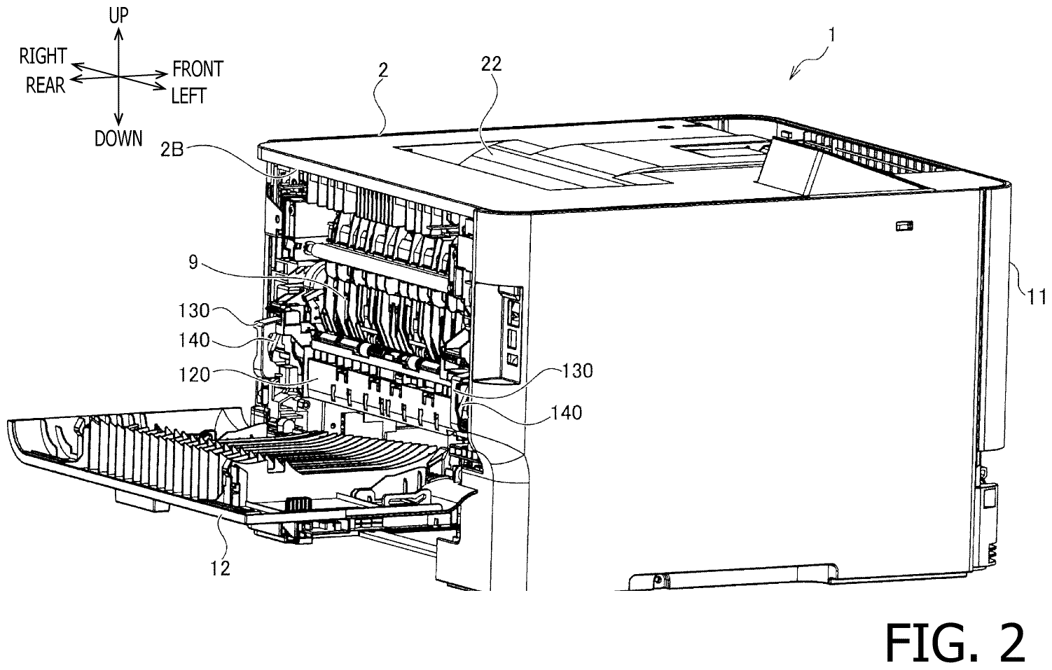

The fuser 9 is attachable to and detachable from the main body 2 through the rear opening 2B of the main body 2, which is exposed by opening the rear cover 12. FIG. 2 shows the rear cover 12 being open. As shown in FIG. 2, the fuser 9 includes a fuser body 120, fixing handles 130, and levers 140. The fixing handles 130 are located respectively at ends of the fuser body 120 on the right and the left, and the lever 140 is attached to each of the fixing handles 130.

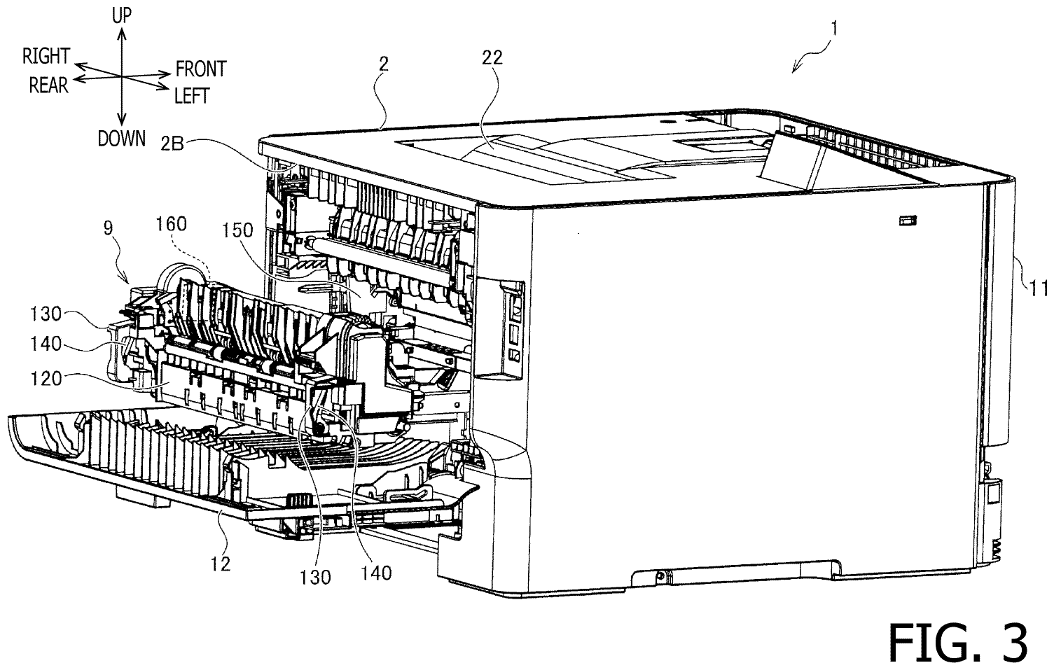

As a user grasps the levers 140 and pulls the fixing handles 130 rearward, the fuser 9 may be detached from the main body 2, as shown in FIG. 3. Moreover, a fuser connector 160 on the fuser 9 is also detached from a main-body connector 150 on the main body 2. In other words, the fuser connector 160 and the main-body connector 150 are connected when the fuser 9 is attached to the main body 2, and are disconnected when the fuser 9 is detached from the main body 2.

At a position (not shown) in the main body 2, where the fuser 9 contacts the main body 2, a fuser detection switch 15 (see FIG. 7) for detecting whether the fuser 9 is mounted to the main body 2 is located. The fuser detection switch 15 is turned on when the fuser 9 is mounted to the main body 2, and is turned off when the fuser 9 is detached from the main body 2.

### Configuration of the Fuser

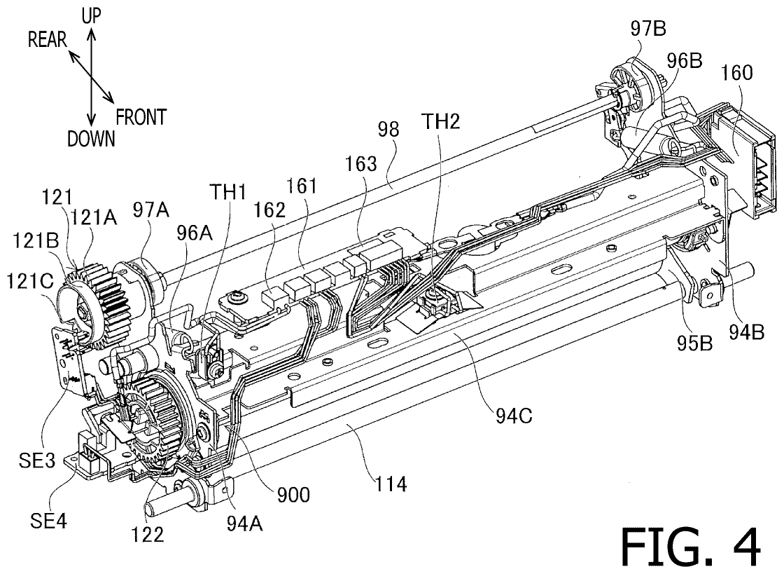

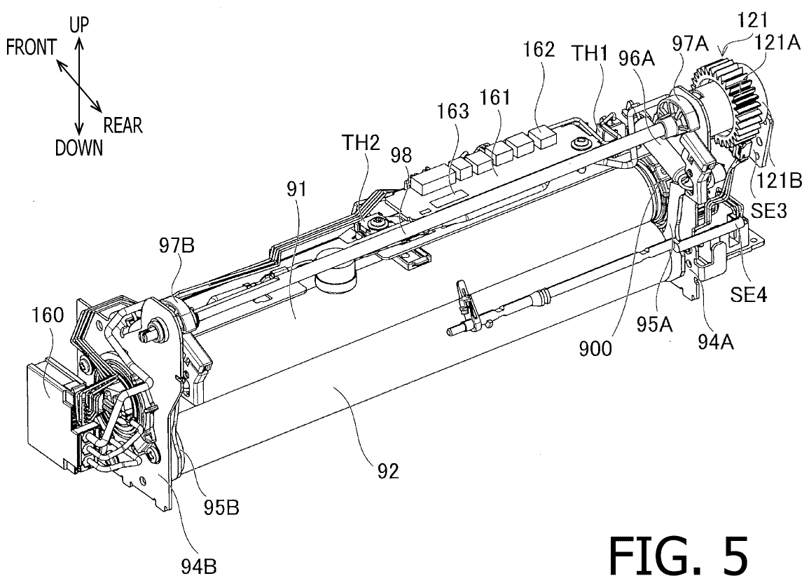

Next, among the components of the printer 1 described above, the fuser 9, which is detachably attached to the main body 2 of the printer 1 and fixes toner image on the sheet S, will be described in more detail with reference to the drawings. FIGS. 4 and 5 are diagrams showing front and rear views, respectively, of an internal structure of the fuser 9, where an outer housing wall of the fuser 9 is removed. In the following description, the front-rear and the up-down directions are as indicated by arrows in the drawings.

The fuser 9 includes the heat roller 91 as an example of the heating rotatable body for heating the sheet S, the pressure roller 92 for nipping the sheet S in cooperation with the heat roller 91, side frames 94A and 94B, a connecting frame 94C, and a press-contact/separation assembly 900.

The heat roller 91 extends in a longitudinal direction and is rotatable about a rotational axis. The heat roller 91 rotates by receiving a driving force from the main motor 201A in the printer 1. The heat roller 91 is a metal tube and is heated by a heater 93 disposed inside. The heater 93 may be, for example, a halogen heater.

In the following description, the longitudinal direction of the heat roller 91 is simply referred to as a longitudinal direction. The longitudinal direction is also a direction of the rotational axis of the heat roller 91. The sheet S is conveyed from the front toward the rear of the fuser 9 and passes through the fuser 9. As shown in FIG. 1, the sheet S passed through the fuser 9 is conveyed upward along the first conveyer path 25.

The pressure roller 92 rotates along with the rotation of the heat roller 91 and nips the sheet S in cooperation with the heat roller 91. The pressure roller 92 may be made of, for example, an elastic member such as rubber.

The side frames 94A, 94B are located at ends on one side and the other side in the longitudinal direction of the heat roller 91 and the pressure roller 92. The side frames 94A, 94B rotatably support the heat roller 91.

The connecting frame 94C is a metal plate extending in the longitudinal direction. The connecting frame 94C connects the side frame 94A on one side in the longitudinal direction and the side frame 94B on the other side in the longitudinal direction.

A cam 97A is located adjacent to the side frame 94A and is supported thereat rotatably with respect to the side frame 94A. Moreover, a cam 97B is located adjacent to the side frame 94B and is supported thereat rotatably with respect to the side frame 94B. The cam 97A and the cam 97B are connected to each other by a cam shaft 98.

The press-contact/separation assembly 900 includes arms 95A, 95B; springs 96A, 96B; and cams 97A, 97B. The press-contact/separation assembly 900 may switch a state of the heat roller 91 and the pressure roller 92 between a press-contact state, in which the heat roller 91 and the pressure roller 92 pressed against each other, and a separated state, in which the heat roller 91 and the pressure roller 92 are separated. The press-contact state and the separated state are switchable by moving at least one of the heat roller 91 and the pressure roller 92 relatively to the other. The press-contact/separation assembly 900 may optionally adjust a nip pressure between the heat roller 91 and the pressure roller 92 in the press-contact state. In particular, in the first embodiment, the press-contact/separation assembly 900 may switch the state between the press-contact state and the separated state by moving the pressure roller 92 relatively to the heat roller 91.

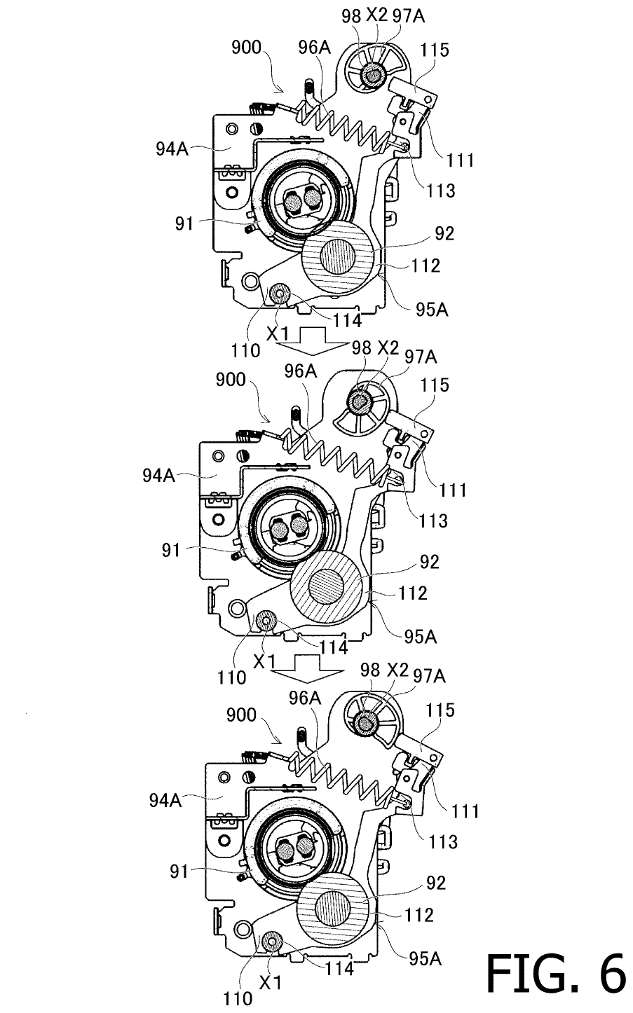

Below, the press-contact/separation assembly 900 will be described with reference to FIG. 6. Behaviors of the arm 95A, the spring 96A, and the cam 97A on the side frame 94A are the same as those of the arm 95B, the spring 96B, and the cam 97B on the side frame 94B; therefore, the following paragraphs will describe exemplary behaviors of the arm 95A, the spring 96A, and the cam 97A on the side frame 94A.

As shown in FIG. 6, the arm 95A includes a first end portion 110, a second end portion 111, a first part 112, and a second part 113. The arm 95A is supported on the side frame 94A rotatably about an arm axis X1 through a shaft 114 at the first end portion 110. The second end portion 111 includes a cam follower 115. The cam follower 115 may contact the cam 97A.

The first part 112 and the second part 113 are located between the first end portion 110 and the second end portion 111. The first part 112 rotatably supports the pressure roller 92. The second part 113 is a part where the spring 96A is connected. One end of the spring 96A is hooked to the second part 113, and the other end of the spring 96A is hooked to the side frame 94A. The spring 96A urges the pressure roller 92 toward the heat roller 91 through the arm 95A.

The cam 97A is rotatably supported on the side frame 94A on the one side in the longitudinal direction through a cam shaft 98, and is rotatable about a cam axis X2. As shown in FIG. 6, the cam 97A has a deformed semicircular shape, and rotates to contact the cam follower 115 and thereby rotate the arm 95A about the arm axis X1. As the arm 95A rotates, the pressure roller 92 is moved relatively to the heat roller 91, thereby switching the state of the press-contact/separation assembly 900 between the press-contact state and the separated state. The cam 97A may rotate in a counterclockwise direction as shown in FIG. 6.

A top diagram in FIG. 6 illustrates the press-contact state where the heat roller 91 and the pressure roller 92 are pressed and in contact with each other. A bottom diagram in FIG. 6 illustrates the separated state where the heat roller 91 and the pressure roller 92 are separated. A diagram in the middle in FIG. 6 illustrates a transitional state from the press-contact state to the separated state.

Next, returning to FIGS. 4 and 5, the fuser 9 will be described further. The fuser 9 includes a cam gear 121 and a fuser gear 122. The cam gear 121 is fixed to an end of the cam shaft 98 on the one side in the longitudinal direction. The cam gear 121 is connected to the cam 97A and the cam 97B through the cam shaft 98 and transmits a driving force to the cam 97A and the cam 97B. The cam gear 121 includes a plurality of gear teeth 121A and a flange 121B extending from a basal part of the gear teeth 121A toward the one side in the longitudinal direction. The flange 121B includes a cutout 121C for detecting a phase of the cam 97A.

The fuser gear 122 includes a plurality of gear teeth. The fuser gear 122 is fixed to an end of the heat roller 91 on the one side in the longitudinal direction. The fuser gear 122 is arranged coaxially with the heat roller 91 and rotates integrally with the heat roller 91 about the rotational axis. The fuser gear 122 transmits the driving force to the heat roller 91.

Moreover, the fuser 9 includes fuser temperature sensors TH1, TH2 for detecting temperatures of the heat roller 91, a nip detection sensor SE3, a discharge sensor SE4, a fuser connector 160, and a relay board 161. The fuser temperature sensors TH1, TH2 are examples of the temperature sensor, the nip detection sensor SE3 is an example of the detection sensor and the first detection sensor, and the discharge sensor SE4 is an example of the detection sensor and the second detection sensor.

The fuser temperature sensor TH1 is a sensor for detecting a temperature of the heat roller 91, in particular, a temperature in a region near the end portion of the heat roller 91. As shown in FIG. 4, the fuser temperature sensor TH1 is fixed with, for example, a screw to the connecting frame 94C in an end area in the longitudinal direction at a position spaced above from the heat roller 91. The fuser temperature sensor TH1 may be, for example, a thermistor.

On the other hand, the fuser temperature sensor TH2 is a sensor for detecting a temperature of the heat roller 91, in particular, a temperature in a region near a center of the heat roller 91. As shown in FIG. 4, the fuser temperature sensor TH2 is fixed with, for example, a screw to the connecting frame 94C in a central area in the longitudinal direction at a position spaced above from the heat roller 91. The fuser temperature sensor TH2 may be, for example, a thermistor.

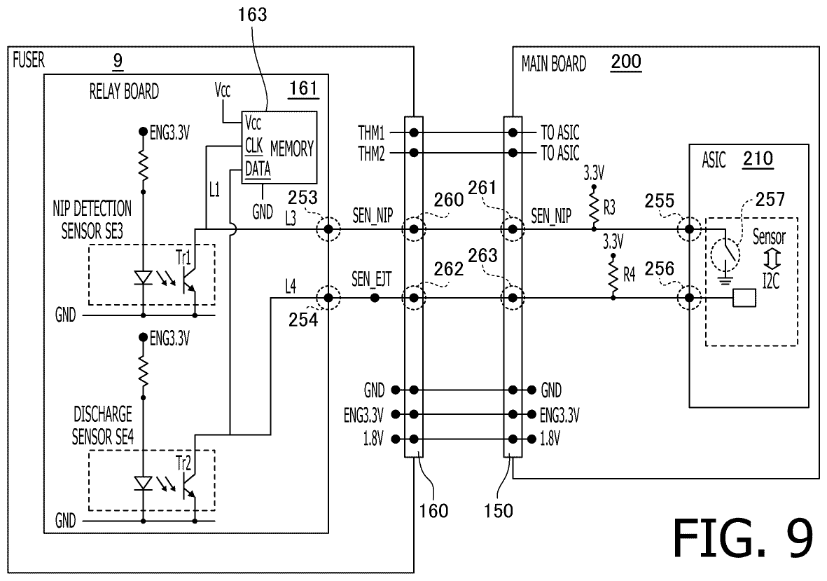

The nip detection sensor SE3 is an optical sensor and includes a light emitter to emit light and a light receiver to receive the light from the light emitter. The light emitter includes, as a light source, a light-emitting diode described later, and the light receiver includes a phototransistor Tr1 (see FIG. 9). In the press-contact state, as shown in the top diagram in FIG. 6, where the heat roller 91 and the pressure roller 92 are in pressed to contact, the light emitted from the light emitter is blocked by the flange 121B of the cam gear 121. On the other hand, when the press-contact/separation assembly 900 is in the separated state as shown in the bottom diagram in FIG. 6, where the heat roller 91 and the pressure roller 92 are separated, the light emitted from the light emitter passes through the cutout 121C formed in the flange 121B of the cam gear 121 and reaches the light receiver without being blocked. As a result, as will be described later, an Application Specific Integrated Circuit (ASIC) 210, which is an example of the controller and is mounted on a main board 200, is enabled to determine that the press-contact/separation assembly 900 is in the separated state when the light receiver receives light, and that the press-contact/separation assembly 900 is in the press-contact state when the light receiver does not receive light.

Optionally, by adjusting the position of the cutout 121C in the flange 121B, the relation between the light-blocking state detectable by the nip detection sensor SE3 and the state of the press-contact/separation assembly 900 may be reversed. In other words, the fuser 9 may be configured such that, in the press-contact state as shown in the top diagram in FIG. 6 where the heat roller 91 and the pressure roller 92 are pressed against each other, the light emitted from the light emitter may be enabled to pass through the cutout 121C to be received by the light receiver; and in the separated state as shown in the bottom diagram in FIG. 6 where the heat roller 91 and the pressure roller 92 are separated, the light from the light emitter may be blocked. In this arrangement, the ASIC 210 may determine that the press-contact/separation assembly 900 is in the press-contact state when the light receiver receives the light, and may determine that the press-contact/separation assembly 900 is in the separated state when the light receiver does not receive the light.

The discharge sensor SE4 is a sensor that may detect the sheet S passed through the nip position between the heat roller 91 and the pressure roller 92. In other words, the discharge sensor SE4 may detect the sheet S, on which the developed image is fixed by the fuser 9. The discharge sensor SE4 includes an actuator rotatable about a rotational axis and a photosensor. When the sheet S passes through the position between the heat roller 91 and the pressure roller 92 and contacts to tilt the actuator, a photosensor near the rotational axis of the actuator detects the tilt of the actuator, thereby detecting that the sheet S, on which the toner image is fixed by the fuser 9, is being discharged. More specifically, the photosensor includes a light emitter to emit light and a light receiver to receive the light from the light emitter. The light emitter includes, as a light source, a light-emitting diode described later, and the light receiver includes a phototransistor Tr2 (see FIG. 9). When the sheet S passes through the nip position and the actuator tilts, the light from the light emitter is not blocked by the actuator, and the light receiver may receive the light. On the other hand, when the sheet S is not at the nip position and the actuator is at the initial position, the light from the light emitter is blocked by the actuator. As a result, as described later, the ASIC 210 in the printer 1 may determine that the sheet S is passing through the nip position when the light receiver is receiving the light, and that the sheet S is not at the nip position when the light receiver is not receiving light.

The fuser connector 160 includes a plurality of terminals. The fuser connector 160 is connected to a main-body connector 150 (see FIG. 3) in the main body 2 when the fuser 9 is attached to the printer 1. The terminals in the fuser connector 160 are connected to respective terminals in the main-body connector 150. The fuser connector 160 is located outside the side frame 94B in the longitudinal direction.

The relay board 161 relays signals from the fuser temperature sensors TH1, TH2, the nip detection sensor SE3, and the discharge sensor SE4 to the fuser connector 160. The relay board 161 includes a plurality of connectors 162 for connection with the respective sensors, and the connectors 162 and the sensors are connected via cables. The connectors 162 include connectors for connection with the fuser connector 160, and such connectors 162 and the fuser connector 160 are connected via cables.

Furthermore, the relay board 161 includes a memory 163 for storing information related to the fuser 9, including identification information, setting parameters, and information concerning a usage count in the past and lifespan of the fuser 9. The relay board 161 has a signal line connected to the memory 163, and relays data signals for reading and writing and clock signals for synchronization between the fuser 9 side and the controller on the printer 1 side. The data signals and the clock signals are examples of the memory signal and the first memory signal.

Moreover, the heater 93 included in the heat roller 91 is connected to the fuser connector 160 by a power cable. Specifically, the heater 93 is connected to the fuser connector 160 by a power cable through a thermostat TM. The thermostat TM has a function to cut off the power when the temperature of the heat roller 91 exceeds a control range and the heat roller 91 is overheated.

In the state where the fuser 9 having the above configuration is attached to the main body 2 of the printer 1, the fuser connector 160 is connected to the main-body connector 150. Once the fuser connector 160 and the main-body connector 150 are connected, temperature information from the fuser temperature sensors TH1, TH2, information concerning the state of the press-contact/separation assembly 900 from the nip detection sensor SE3, information concerning the sheet S from the discharge sensor SE4, and data signals for reading and writing with the memory 163 may be transmitted to the controller in the printer 1. Furthermore, the clock signals may be transmitted from the controller in the printer 1 to the memory 163. Moreover, when the fuser connector 160 and the main-body connector 150 are connected, power may be supplied from a power board in the main body 2 to the heater 93. The power board is controlled by the ASIC 210, and supplies power to the heater 93 based on the temperature information detected by the fuser temperature sensors TH1, TH2.

### Electrical Configuration of the Printer

Next, an electrical configuration of the printer 1, including the fuser 9, will be described with reference to FIG. 7. FIG. 7 shows the electrical configuration of the printer 1 including the fuser 9. In FIG. 7, main components in the first embodiment are mainly described, while description of the other components of the printer 1 may be omitted.

As shown in FIG. 7, the main body 2 includes boards, including the main board 200, a main motor board 201, a high-voltage power board 202, and a low-voltage power board 203. These boards are connected to one another via harnesses. The main motor 201A is mounted on the main motor board 201. When the main motor 201A is driven, the heat roller 91 in the fuser 9 and the rollers in the conveyer 3 rotate. The main board 200 is an example of the control board in the printer 1.

The high-voltage power board 202 supplies high voltages HV, such as developing voltage and charging voltage, to the process unit 4. The high-voltage power board 202 includes a high-voltage generating circuit 202C. The high-voltage generating circuit 202C generates the high voltage HV of, for example, approximately 1 kV, based on a DC voltage (e.g., DC 24V) supplied from the low-voltage power board 203 via the main board 200, and supplies the generated high voltage HV to the process unit 4.

The main board 200 and the high-voltage power board 202 are connected via a first connection line CA1. In order to control the high-voltage power board 202, the ASIC 210 mounted on the main board 200 communicates with the high-voltage power board 202 to transmit and receive control signals to and from the high-voltage power board 202, and the first connection line CA1 is used for the communication. For transmission of a plurality of control signals, a plurality of signal lines are provided; therefore, the first connection line CA1 may be in a form of a harness bundling the plurality of signal lines.

The low-voltage power board 203 includes an AC-DC conversion circuit 203C. The low-voltage power board 203 receiving an AC voltage (e.g., AC 100V) from a commercial power source converts the AC voltage to a DC voltage (e.g., DC 24V) via the AC-DC conversion circuit 203C. The low-voltage power board 203 is connected to the main board 200 via a fourth connection line CA4 and outputs the generated DC 24V to the main board 200.

The main board 200 includes a DC-DC conversion circuit 211 and converts the DC 24V from the low-voltage power board 203 into DC 3.3V with the DC-DC conversion circuit 211. This DC 3.3V is a voltage used to drive the electronic devices mounted on the main board 200. However, in a case where devices to be driven by other DC voltages (e.g., DC 5 V) are provided, multiple DC-DC conversion circuits may be provided to generate, for example, DC 5V in addition to the DC 3.3V.

As for the 3.3V DC voltage, the DC-DC conversion circuit 211 generates a separate ENG 3.3V from the 3.3V DC used to drive the electric devices mounted on the main board 200. The DC-DC conversion circuit 211 supplies the ENG 3.3V and the DC 1.8V to the fuser 9 via the main-body connector 150. The main board 200 includes a ground portion GND serving as a reference potential for operating circuits such as the ASIC 210, and is connected to a GND terminal which is one of the plurality of terminals in the main-body connector 150. The relay board 161 in the fuser 9 may operate the fuser temperature sensors TH1, TH2, the nip detection sensor SE3, and the discharge sensor SE4 by using the supplied voltages and the ground potential, and output signals from these sensors to the ASIC 210. More specifically, the fuser temperature sensor TH1, the nip detection sensor SE3, and the discharge sensor SE4 are operated by the ENG 3.3V, while the fuser temperature sensor TH2 is operated by the DC 1.8V.

When the printer 1 is in a “standby mode” and does not receive an execution command for image forming or data for image forming, and a predetermined time elapses after transitioning to the “standby mode,” a power consumption mode shifts from the “standby mode” to a “sleep mode.” The “sleep mode” is a lower power consumption mode than the “standby mode,” in which, for example, the display may be turned off and a CPU clock may be lowered, and the supply of the ENG 3.3V may be stopped. Meanwhile, the DC 3.3V and the DC 1.8V may be supplied continuously. When the printer 1 receives an execution command for image forming data for image forming in the “sleep mode,” the printer 1 may return to the “standby mode” and print the image. The standby mode is an example of a non-power-saving mode, and the sleep mode is an example of a power-saving mode.

The low-voltage power board 203 is connected to the main-body connector 150 via a third connection line CA3, and is connected to an inlet 204 via a fifth connection line CA5. The inlet 204 is for receiving an AC voltage supplied from a commercial power source. The AC voltage may be, for example, AC 100V. This AC voltage is also supplied to the fuser 9 via the inlet 204, the fifth connection line CA5, the low-voltage power board 203, the third connection line CA3, the main-body connector 150, and the fuser connector 160. The AC voltage supplied to the fuser 9 is supplied to the heater 93 via the thermostat TM.

The ASIC 210 mounted on the main board 200 may include, for example, a CPU, a memory, and I/O circuits, which are not shown, and perform various arithmetic processes based on programs and data stored in the memory to control the entire printer 1 including the process unit 4. The memory is embedded and may be configured as a combination of, for example, ROM, RAM, NVRAM, SSD, and/or HDD. The memory may be used when executing programs.

The main board 200 includes, further to the ASIC 210, a motor drive circuit MD for driving the main motor 201A, an ON/OFF circuit 212 for switching supplying or not supplying of DC 24V to the high-voltage generating circuit 202C of the high-voltage power board 202, a detection circuit (DET) 213 for detecting an ON or OFF state of the fuser detection switch 15, which may detect whether the fuser 9 is attached to the main body 2, and the DC-DC conversion circuit 211.

The AC-DC conversion circuit 203C on the low-voltage power board 203 is connected to the DC-DC conversion circuit 211 via a power line PL. The power line PL connecting the AC-DC conversion circuit 203C and the DC-DC conversion circuit 211 is a part of the fourth connection line CA4. The power line PL branches on the main board 200, at a branching point BP0 which is a position upstream of the DC-DC conversion circuit 211, and the branch extends to be connected to an input side of the fuser detection switch 15.

An output side of the fuser detection switch 15 is connected to an input side of the ON/OFF circuit 212 via a power line PL, which is branched at a first branching point BP1 located between the output side of the fuser detection switch 15 and the input side of the ON/OFF circuit 212 and connected to an input side of the motor drive circuit MD. Further, the output side of the fuser detection switch 15 is connected to an input side of the detection circuit 213 via a power line L, which is branched at a second branching point BP2 located downstream from the first branching point PB1 and between the output side of the fuser detection switch 15 and the input side of the ON/OFF circuit 212.

An output side of the motor drive circuit MD is connected to the main motor 201A. To the motor drive circuit MD, the voltage applied to the first branching point BP1 on the power line PL is supplied. To the first branching point BP1, the output voltage from the fuser detection switch 15 is applied; therefore, when the fuser detection switch 15 is on, DC 24V is applied, and when the fuser detection switch 15 is off, 0V is applied.

To the motor drive circuit MD, a signal EN from an output port of the ASIC 210 is input. The signal EN is a signal to enable or disable the motor drive circuit MD. For example, when the signal EN is H, the motor drive circuit MD may be enabled, and when the signal EN is L, the motor drive circuit MD may be disabled. However, even if the signal EN being H is input, the motor drive circuit MD may not operate unless the DC 24V is also applied thereto. In other words, while the DC 24V is applied to the motor drive circuit MD and when the signal EN being H is input, the motor drive circuit MD starts operating, and while the DC 24V is applied to the motor drive circuit MD and when the signal EN being L is input, the motor drive circuit MD stops operating. Therefore, when 0V is applied, the motor drive circuit MD stops operating regardless of the value of the EN signal. The method to control the main motor 201A by the motor drive circuit MD may be any known method, and description of the method is herein omitted.

Meanwhile, an output side of the ON/OFF circuit 212 is connected to a power voltage input side of the high-voltage generating circuit 202C on the high-voltage power board 202. To the high-voltage generating circuit 202C, further, control signals from an output port (not shown) of the ASIC 210 is input. The high-voltage generating circuit 202C may include, for example, a booster circuit with a transformer or a transformer drive circuit. Based on the input DC 24V and the control signals, the high-voltage generating circuit 202C may boost the voltage and supply the generated high voltages H, including charging voltage, developing voltage, and transfer voltage, to the process unit 4.

The ASIC 210 outputs an HVEN signal to the ON/OFF circuit 212. The HVEN signal is a control signal for the ON/OFF circuit 212 and may indicate either an ON (H) or OFF (L) value. When the DC 24V is supplied from the fuser detection switch 15, the ON/OFF circuit 212 switches supplying or not supplying the DC 24V to the high-voltage generating circuit 202C based on the value of the HVEN signal from the ASIC 210.

An output side of the detection circuit 213 is connected to an input port (not shown) of the ASIC 210. The ASIC 210 determines that the fuser detection switch 15 is in the ON state when the detection signal from the detection circuit 213 is L, and determines that the fuser detection switch 15 is in the OFF state when the detection signal is H.

The input port of the ASIC 210 is connected to an output side of a rear cover open/close detection switch 16 that may detect opening and closing movements of the rear cover 12. The rear cover open/close detection switch 16 is located near the rear cover 12 and outputs a rear cover open/close signal that indicates a value corresponding to the rear cover 12 being open or closed. The ASIC 210 may determine whether the rear cover 12 is open or closed by monitoring the value of the rear cover open/close signal.

The input port of the ASIC 210 is also connected to output sides of the sheet feed sensor 44, the pre-registration sensor 45, and the post-registration sensor 46 arranged on the first conveyer path 25. The ASIC 210 monitors the signals from the sheet feed sensor 44, the pre-registration sensor 45, the post-registration sensor 46, and the discharge sensor SE4 in the fuser 9 to determine a conveyance status of the sheet S in the first conveyer path 25.

The main board 200 is connected to the high-voltage power board 202 via a connector 200A on the main board 200 side, the first connection line CA1, and a connector 202A on the high-voltage power board 202 side. The high-voltage power board 202 is connected to the main-body connector 150 via a connector 202B on the high-voltage power board 202 side and a second connection line CA2.

As described above, the main body 2 includes the inlet 204, and the AC voltage supplied via the inlet 204 is input to the low-voltage power board 203 via a connector 203A on the low-voltage power board 203d side. The low-voltage power board 203 is connected to the main-body connector 150 via a connector 203B on the low-voltage power board 203 side and a third connection line CA3.

When the fuser 9 is attached to the main body 2 of the printer 1, the main-body connector 150 is connected to the fuser connector 160. The fuser connector 160 is connected to the relay board 161 on the fuser 9 via a connector 161A on the relay board 161 side. As described above, the fuser 9 includes the heater 93. The heater 93 is supplied with an AC voltage (e.g., AC 100V) from the inlet 204 via the low-voltage power board 203, the third connection line CA3, the main-body connector 150, and the fuser connector 160.

The heater 93 is heated by the AC 100V supplied as above. When the AC 100V is supplied to the heater 93, the ASIC 210 controls the heating temperature of the heater 93 by adjusting timing to switch the AC 100V on or off. In order to control the temperature of the heater 93, the fuser temperature sensors TH1, TH2, as previously described, are provided. The fuser temperature sensors TH1, TH2 are two separate sensors as shown in FIG. 4.

The fuser temperature sensor TH1 for detecting the temperature at the end portion of the heat roller 91 is supplied with the ENG 3.3V from the relay board 161 and operates on this ENG 3.3V voltage. On the other hand, the fuser temperature sensor TH2 for detecting the temperature at the central portion of the heat roller 91 is supplied with the DC 1.8V and operates on this DC 1.8V voltage. By using these fuser temperature sensors TH1, TH2 operable on different voltages, even in a case where the power line is disconnected or the DC-DC conversion circuit 211 fails, the temperature of the heat roller 91 may be detected by at least one of the fuser temperature sensors. Moreover, when the printer 1 shifts to the sleep mode, supply of the ENG 3.3V is stopped while supply of the DC 1.8V is maintained, enabling the fuser temperature sensor TH2 to operate even when the printer 1 is in the sleep mode.

The fuser temperature sensors TH1, TH2 output signals THM1, THM2, respectively, and the fuser 9 transmits these signals THM1, THM2 to the main board 200 so that the ASIC 210 may control the heating temperature of the heater 93. More specifically, the signals THM1, THM2 are transmitted via the relay board 161, the fuser connector 160, the main-body connector 150, the second connection line CA2, the high-voltage power board 202, and the first connection line CA1 to the main board 200. The ASIC 210 on the main board 200 controls the timing to switch the AC 100V supplied to the heater 93 on or off based on the signals THM1, THM2 from the fuser temperature sensors TH1, TH2. The fuser 9 also transmits the detection signals from the nip detection sensor SE3 and the discharge sensor SE4 to the main board 200.

### Electrical Configuration of the Relay Board

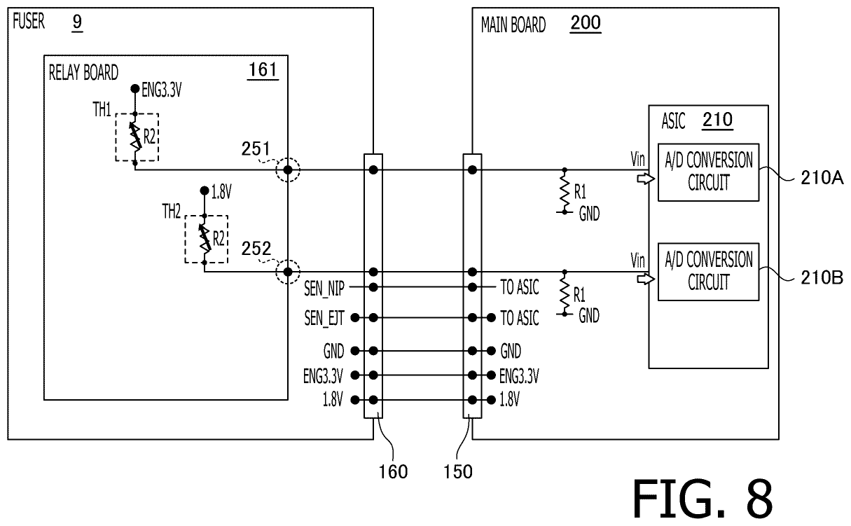

Next, more detailed electrical configuration of the relay board 161 in the fuser 9 in the above-described electrical configuration of the printer 1 will be described with reference to FIGS. 8 and 9. FIGS. 8 and 9 illustrate particularly the relay board 161 in the fuser 9 and the electrical configuration of the printer 1 related to the relay board 161.

First, with reference to FIG. 8, the fuser temperature sensor TH1 (see FIG. 4) in the fuser 9 will be described. The fuser temperature sensor TH1 has a variable resistor R2, of which resistance varies depending on the detected temperature. One end of the variable resistor R2 is connected to the power source of the ENG 3.3V on the relay board 161, and the other end is connected via a signal line to a terminal of the fuser connector 160. The relay board 161 relays the signal from the fuser temperature sensor TH1 to the main board 200 via a dedicated temperature sensor output terminal 251. Meanwhile, on the main board 200 side, the ASIC 210 has a terminal, which is connected to the temperature sensor output terminal 251 and to which the signal from the fuser temperature sensor TH1 is input, and one end of a resistor R1 with a predetermined resistance value is connected to the terminal. The other end of the resistor R1 is connected to the ground portion GND of the main board 200. The ASIC 210 includes an A/D conversion circuit 210A. Accordingly, an analog voltage, which is originally ENG 3.3 V from the fuser temperature sensor TH1 but is split by the variable resistor R2 and the resistor R1, is input to the A/D conversion circuit 210A in the ASIC 210. More specifically, an analog voltage, which is originally ENG 3.3V from the fuser temperature sensor TH1 but is split by the variable resistor R2 and the resistor R1, is input to the A/D conversion circuit 210A in the ASIC 210, and the ASIC 210 determines the temperature detected by the fuser temperature sensor TH1 based on a digital value converted by the A/D conversion circuit 210A. To the A/D conversion circuit 210A, the analog voltage signal expressed by the following Equation (1) is input:

$$Vin = 3.3 V * R 1 / ( Variable R 2 + R 1 ) \qquad ( 1 )$$

As the detected temperature changes, the resistance of the variable resistor R2 changes, and accordingly, the analog voltage Vin varies.

Next, with reference to FIG. 8, the fuser temperature sensor TH2, i.e., the sensor to detect the temperature in the central area of the heat roller 91 (see FIG. 4), in the fuser 9 will be described. The fuser temperature sensor TH2 has a variable resistor R2, of which resistance varies depending on the detected temperature. One end of the variable resistor R2 is connected to the power source of the DC 1.8V on the relay board 161, and the other end is connected via a signal line to a terminal of the fuser connector 160. The relay board 161 relays the signal from the fuser temperature sensor TH2 to the main board 200 via a dedicated temperature sensor output terminal 252. Meanwhile, on the main board 200 side, the ASIC 210 has a terminal, which is connected to the temperature sensor output terminal 252 and to which the signal from the fuser temperature sensor TH2 is input, and one end of a resistor R1 with a predetermined resistance value is connected to the terminal. The other end of the resistor R1 is connected to the ground portion GND of the main board 200. The ASIC 210 includes an A/D conversion circuit 210B. Accordingly, an analog voltage, which is originally 1.8V from the fuser temperature sensor TH2 but is split by the variable resistor R2 and the resistor R1, is input to the A/D conversion circuit 210B in the ASIC 210. More specifically, an analog voltage, which is originally 1.8V from the fuser temperature sensor TH2 but is split by the variable resistor R2 and the resistor R1, is input to the A/D conversion circuit 210B in the ASIC 210, and the ASIC 210 determines the temperature detected by the fuser temperature sensor TH2 based on a digital value converted by the A/D conversion circuit 210B. To the A/D conversion circuit 210B, the analog voltage signal expressed by the following Equation (2) is input:

$$Vin = 1.8 V * R 1 / ( Variable R 2 + R 1 ) \qquad ( 2 )$$

As the detected temperature changes, the resistance of the variable resistor R2 changes, and accordingly, the analog voltage Vin varies.

As described above, to each of the fuser temperature sensor TH1 and the fuser temperature sensor TH2, the resistor R1 is provided on the main board 200 side and the ground portion GND is connected to the resistor R1; therefore, the analog voltage Vin described above is a potential with respect to the ground portion GND of the main board 200, rather than the ground portion GND of the relay board 161. This may prevent ground potential shifts during analog-to-digital conversion in the A/D conversion circuits 210A, 210B, and the temperatures may be detected more accurately.

The voltages of the ENG 3.3V and the DC 1.8V from the power source in the relay board 161 are generated by the DC-DC conversion circuit 211 on the main board 200 and supplied to the fuser 9 via the main-body connector 150 (see FIG. 7).

Next, with reference to FIG. 9, the nip detection sensor SE3, the discharge sensor SE4, and the memory 163 in the fuser 9 are described. The nip detection sensor SE3 includes a light-emitting diode and a phototransistor Tr1, and the discharge sensor SE4 includes a light-emitting diode and a phototransistor Tr2. The memory 163 is a storage medium that stores information related to the fuser 9, such as identifying information, setting parameters, information concerning a usage count in the past and lifespan of the fuser 9. The memory 163 includes a CLK terminal and a DATA terminal, which are connected to the first memory connection line L1 being a signal line and a second memory connection line L2 being a signal line, respectively. The relay board 161 relays data signals for reading data and clock signals for synchronization between the memory 163 and the ASIC 210 in the main board 200 through these signal lines. Further, the memory 163 is connected to the ground portion GND and the power source. The phototransistor Tr1 is an example of the switching device and the first switching device, and phototransistor Tr2 is an example of the switching device and the second switching device.

First, the description will focus on the nip detection sensor SE3 and the memory 163. In order to reduce the number of the terminals in the fuser connector 160 and the main-body connector 150, for transmission of the detection signal from the nip detection sensor SE3 and the clock signal from the memory 163, a common signal line is shared. Specifically, the relay board 161 includes a first line L3, one end of which is connected to a first common terminal 253, and a first memory connection line L1, one end of which is connected to the CLK terminal of the memory 163. The other end of the first line L3 is connected to the nip detection sensor SE3, and the other end of the first memory connection line L1 is connected to the first line L3. The fuser connector 160 includes a first fuser common terminal 260, which is connected via a signal line to the first common terminal 253. Thus, the relay board 161 relays both the signal from the nip detection sensor SE3 to the main board 200 and the clock signal from the main board 200 to the memory 163 via the same first common terminal 253 and the same first fuser common terminal 260.

On the other hand, the main-body connector 150 on the main board 200 side includes a first main-body common terminal 261 connected to the fuser common terminal 260. The first main-body common terminal 261 and a first controller terminal 255 of the ASIC 210 are interconnected via a signal line. In other words, the first controller terminal 255 is connected to the first common terminal 253 via the first fuser common terminal 260 and the first main-body common terminal 261. Further, the main board 200 includes a resistor R3 with a predetermined resistor value. The resistor R3 is connected on one end to the first controller terminal 255 of the ASIC 210, through which the signal from the nip detection sensor SE3 and the clock signal to the memory 163 are transmitted. On the other end, the resistor R3 is connected to the power source of the DC 3.3V on the main board 200. In other words, the first line L3 is connected to the power source of the DC 3.3V via the main-body connector 150 and the fuser connector 160. The light-emitter of the phototransistor Tr1 is connected to the ground portion GND of the relay board 161, and a collector of the phototransistor Tr1 is connected to the first common terminal 253 via the first line L3. The power source of the DC 3.3V on the main board 200 is an example of the first power source. The ground portion GND of the relay board 161 is an example of the board ground. The phototransistor Tr1 switches connection and disconnection between the ground portion GND and the first common terminal 253 according to a status of the fuser 9, in other words, a detection result output from the nip detection sensor SE3, as below.

As described above, in the press-contact/separation assembly 900 in the fuser 9, when the heat roller 91 and the pressure roller 92 are in the press-contact state as shown in the top diagram in FIG. 6, the light from the light-emitting diode is blocked by the flange 121B on the cam gear 121, and thus does not reach the phototransistor Tr1. In the OFF state where the light does not enter the phototransistor Tr1, the ground portion GND of the relay board 161 and the first common terminal 253 are in a disconnected state. Therefore, no current flows from the power source of the DC 3.3V on the main board 200 toward the collector or the emitter of the phototransistor Tr1, and the voltage to be input to the first controller terminal 255 of the ASIC 210 is “3.3V−current I (=0)*R3,” which is 3.3V. As a result, while press-contact/separation assembly 900 is in the press-contact state, 3.3V from the power source of DC 3.3V of the main board 200 is input to the first controller terminal 255 of the ASIC 210.

On the other hand, as described above, in the press-contact/separation assembly 900 in the fuser 9, when the heat roller 91 and the pressure roller 92 are in the separated state as shown in the bottom diagram in FIG. 6, the light from the light-emitting diode enters the phototransistor Tr1 without being blocked by the flange 121B on the cam gear 121. In the ON state where the light enters the phototransistor Tr1, the ground portion GND of the relay board 161 and the first common terminal 253 are in a connected state. Therefore, current flows from the power source of the DC 3.3V on the main board 200 toward the collector and the emitter of the phototransistor Tr1, which is regarded as having zero resistance, and the voltage to be input to the first controller terminal 255 of the ASIC 210 is “3.3V−current I*R3.” However, the resistance value of the resistor R3 is preset so that the voltage value input to the first controller terminal 255 becomes 0V. As a result, while in the separated state, 0V is input to the first controller terminal 255 of the ASIC 210.

As a result, in a state where detection of the status of the fuser 9 is required, such as in a case when the fuser 9 is operating to execute a fusing process, the ASIC 210 is enabled to determine whether the press-contact/separation assembly 900 is in the press-contact state or the separated state based on the voltage input to the first controller terminal 255 from the power source of the main board 200. Specifically, when the phototransistor Tr1 is off, 3.3V (≠0V) is input to the ASIC 210; therefore, the press-contact state between the heat roller 91 and the pressure roller 92 is detectable. On the other hand, when the phototransistor Tr1 is on, 0V is input to the ASIC 210; therefore, when the voltage to be input indicates the value of 0V, the separated state where the heat roller 91 and the pressure roller 92 are separated is detectable.

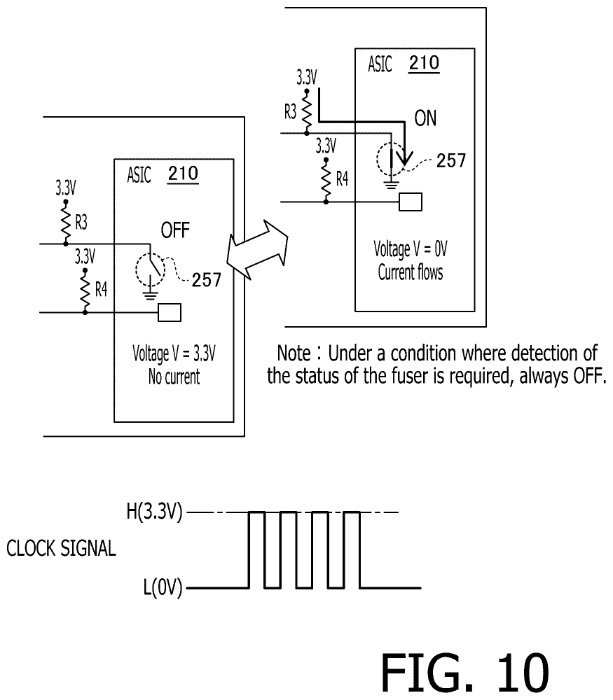

Meanwhile, as shown in FIG. 9, the ASIC 210 includes the ground portion GND connected to the first controller terminal 255, and an internal switch 257 for switching connection and disconnection between the first controller terminal 255 and the ground portion GND. In the press-contact state of the press-contact/separation assembly 900, that is, while the voltage of 3.3V is being input to the first controller terminal 255 of the ASIC 210, when the internal switch 257 of the ASIC 210 is alternately turned on and off, connection between the first controller terminal 255 and the ground portion GND is repeatedly switched between the connected state and the disconnected state, and as shown in FIG. 10, a High signal of 3.3V and a Low signal of 0V are output repeatedly from the ASIC 210 to the CLK terminal of the memory 163. These High signal and Low signal form a clock signal, which serves as a reference when the ASIC 210 reads data from the memory 163. In the state where detection of the status of the fuser 9 is required, such as in a case when an image is being formed, that is, in a state where the nip detection sensor SE3 is sensing, the internal switch 257 of the ASIC 210 is generally turned off, and the first controller terminal 255 and the ground portion GND are in the disconnected state.

As described above, in the state where detection of the status of the fuser 9 is required, the status is detected using the nip detection sensor SE3. Meanwhile, a state where detection of the status of the fuser 9 is not generally required includes, for example, (a) a state before receiving an instruction to the process unit 4 to form an image on the sheet S; (b) a state after completion of forming an image on the sheet S; and (c) even when an image is being formed, a state where the sheet S is located upstream in the conveyer path from the nip position of the fuser 9. Therefore, in such states, the ASIC 210 may transmit the clock signal to the memory 163 in place of receiving of the detection signal from the nip detection sensor SE3 through the first line L3 and the first common terminal 253. Specifically, in the state where detection of the status of the fuser 9 is not required, and when an instruction to read data from the memory 163 is received, the ASIC 210 switches a function of the relevant pin in the ASIC 210 from input of the sensor information to Inter-Integrated Circuit (I2C). Moreover, the ASIC 210 toggles the internal switch 257 on and off repeatedly. Accordingly, a clock signal for synchronization is transmitted from the ASIC 210, via the first controller terminal 255, the first main-body common terminal 261 in the main-body connector 150, the first fuser common terminal 260 in the fuser connector 160, and the first common terminal 253, to the memory 163. In other words, in the state where detection of the status of the fuser 9 is required, the status of the fuser 9 is detected by the nip detection sensor SE3; on the other hand, in the state where detection of the status of the fuser 9 is not required, the same signal lines and the connector terminals are used to transmit the clock signal to the memory 163. During the time when the clock signal is being transmitted, the nip detection sensor SE3 is disabled for detecting the status of the fuser 9. However, in such a state where detection of the status of the fuser is not required, absence of the detection may not cause a significant problem. As a result, dedicated signal lines or connector terminals for accessing the memory 163 may be omitted, and the number of the terminals in the fuser connector 160 and the main-body connector 150 may be reduced by sharing the existing signal lines and connector terminals of the sensors.

However, when the press-contact/separation assembly 900 is in the separated state, in other words, when voltage of 0V is input to the first controller terminal 255 of the ASIC 210, even if the internal switch 257 of the ASIC 210 is toggled on and off, the voltage remains at 0V, and the clock signal may not be output. Therefore, in order to transmit the clock signal to the memory 163 through the first common terminal 253, the ASIC 210 particularly sets the press-contact/separation assembly 900 in the press-contact state, where the phototransistor Tr1 disconnects the ground portion GND and the first common terminal 253.

Next, the discharge sensor SE4 and the memory 163 will be described in detail. In order to reduce the number of terminals in the fuser connector 160 and the main-body connector 150, in the relay board 161, for transmission of the detection signal from the discharge sensor SE4 and the data signal from the memory 163, a common signal line is shared. Specifically, the relay board 161 includes a second line L4, one end of which is connected to a second common terminal 254, and a second memory connection line L2, one end of which is connected to a DATA terminal in the memory 163. The other end of the second line L4 is connected to the discharge sensor SE4, and the other end of the second memory connection line L2 is connected to the second line L4. The fuser connector 160 includes a second fuser common terminal 262, which is connected via a signal line to the second common terminal 254. Thus, the relay board 161 relays both the signal from the discharge sensor SE4 to the main board 200 and the clock signal from the main board 200 to the memory 163 via the same second common terminal 254 and the same second fuser common terminal 262.

On the other hand, the main-body connector 150 on the main board 200 side includes a second main-body common terminal 263 connected to the second fuser common terminal 262. The second main-body common terminal 263 and a second controller terminal 256 of the ASIC 210 are interconnected via a signal line. In other words, the second controller terminal 256 is connected to the second common terminal 254 via the second fuser common terminal 262 and the second main-body common terminal 263. Further, the main board 200 includes a resistor R4 with a predetermined resistor value. The resistor R4 is connected on one end to the second controller terminal 256 of the ASIC 210, through which the signal from the discharge sensor SE4 and the data for the memory 163 are transmitted. On the other end, the resistor R4 is connected to the power source of the DC 3.3V provided to the main board 200. In other words, the second line L4 is connected to the power source of the DC 3.3V via the main-body connector 150 and the fuser connector 160. The light-emitter of the phototransistor Tr2 is connected to the ground portion GND of the relay board 161, and a collector of the phototransistor Tr2 is connected to the second common terminal 254 via the second line L4. The power source of the DC 3.3V on the main board 200 is an example of the second power source. The ground portion GND of the relay board 161 is an example of the board ground. The phototransistor Tr2 switches connection and disconnection between the ground portion GND and the second common terminal 524 depending on whether the sheet S passed through the nip position, in other words, according to a detected result from the discharge sensor SE4, as below.

As described above, with regard to the discharge sensor SE4 in the fuser 9, when the sheet S is passing through the nip position between the heat roller 91 and the pressure roller 92, the light from the light-emitting diode enters the phototransistor Tr2 without being blocked by the actuator. In the ON state where the light enters the phototransistor Tr2, the ground portion GND of the relay board 161 and the second common terminal 254 are in a connected state. Therefore, current flows from the power source of the DC 3.3V on the main board 200 toward the collector and the emitter of the phototransistor Tr2, which is regarded as having zero resistance, and the voltage to be input to the second controller terminal 256 of the ASIC 210 is “3.3V−current I*R4.” However, the resistance value of the resistor R4 is preset so that the voltage value input to the second controller terminal 256 becomes 0V. As a result, while in the state where the sheet S is passing through the nip position between the heat roller 91 and the pressure roller 92, 0V is input to the second controller terminal 256 of the ASIC 210.

On the other hand, as described above, with regard to the discharge sensor SE4 in the fuser 9, when the sheet S is not at the nip position between the heat roller 91 and the pressure roller 92, the light from the light-emitting diode is blocked by the actuator and does not reach the phototransistor Tr2. In the OFF state where the light does not enter the phototransistor Tr2, the ground portion GND of the relay board 161 and the second common terminal 254 are in a disconnected state. Therefore, no current flows from the power source of the DC 3.3V on the main board 200 toward the collector or the emitter of the phototransistor Tr2, and the voltage to be input to the second controller terminal 256 of the ASIC 210 is “3.3V−current I (=0)*R4,” which is 3.3V. As a result, while the sheet S is not at the position between the heat roller 91 and the pressure roller 92, 3.3V from the power source of the DC 3.3V of the main board 200 is input to the second controller terminal 256 of the ASIC 210.

As a result, in the state where detection of the status of the fuser 9 is required, such as in a case when the fuser 9 is operating to execute a fusing process, the ASIC 210 is enabled to determine whether the sheet S passed through the nip position or not based on the voltage input to the second controller terminal 256 from the power source of the main board 200. Specifically, when the phototransistor Tr2 is on, 0V is input to the ASIC 210; therefore, when the voltage input indicates the value of 0V, the ASIC 210 is enabled to detect that sheet S is passing through the nip position between the heat roller 91 and the pressure roller 92. On the other hand, when the phototransistor Tr2 is off, 3.3V (≠0V) is input to the ASIC 210; therefore, the ASIC 210 is enabled to detect the sheet S being absent at the nip position between the heat roller 91 and the pressure roller 92.

As described above, the sheet S passed through the nip position may be determined using the discharge sensor SE4. Meanwhile, a state where detection of the status of the fuser 9 is not generally required, more specifically, a state where detection of the sheet S passed through the nip position in the fuser 9 is not generally required includes, for example, (a) a state before receiving an instruction to the process unit 4 to form an image on the sheet S; (b) a state after completion of forming an image on the sheet S; and (c) even when an image is being formed, a state where the sheet S is located upstream in the conveyer path from the nip position of the fuser 9. Therefore, in such states, the ASIC 210 may communicate with the memory 163 to transmit or receive the data signal to or from the memory 163 in place of receiving the detection signal from the discharge sensor SE4 through the second line L4 and the second common terminal 254. Specifically, in the state where detection of the sheet S passed through the nip position in the fuser 9 is not required, and when an instruction to read data from the memory 163 is received, the ASIC 210 switches a function of the relevant pin in the ASIC 210 from input of the sensor information to Inter-Integrated Circuit (I2C). As the relevant pin has the I2C function, the data signal is transmitted from the memory 163, through the second common terminal 254, the second fuser common terminal 262 in the fuser connector 160, the second main-body common terminal 263 in the main-body connector 150, and the second controller terminal 256, to the ASIC 210. On the other hand, if an instruction to update the memory 163 is input to the ASIC 210, the data signal is transmitted from the ASIC 210, through the second controller terminal 256, the main-body connector 150, the fuser connector 160, and the second common terminal 254, to the memory 163. In other words, in the state where detection of the sheet S passed through the nip position in the fuser 9 is required, the status of the sheet S is detected by the discharge sensor SE4; on the other hand, in the state where detection of the sheet S passed through the nip position in the fuser 9 is not required, the same signal lines and the connector terminals are used for communication of the data signal between the ASIC 210 and the memory 163. In the context of the present disclosure, communication of a signal (e.g., the data signal) between one (e.g., the ASIC 210) and the other (e.g., the memory 163) includes transmission of a signal from the one to the other and receiving of the signal by the other and/or transmission of a data signal from the other and receiving of the signal by the one. During the time when the data signal is being transmitted or received, the discharge sensor SE4 is disabled for detecting the sheet S passed through the nip position. However, in a such state where detection of the sheet S passed through the nip position is not required, absence of the detection may not cause a significant problem. As a result, a dedicated signal lines or connector terminals for accessing the memory 163 may be omitted, and the number of terminals of the fuser connector 160 and the main-body connector 150 may be reduced by sharing the existing signal lines and connector terminals of the sensors.

### Controlling Process by the Controller

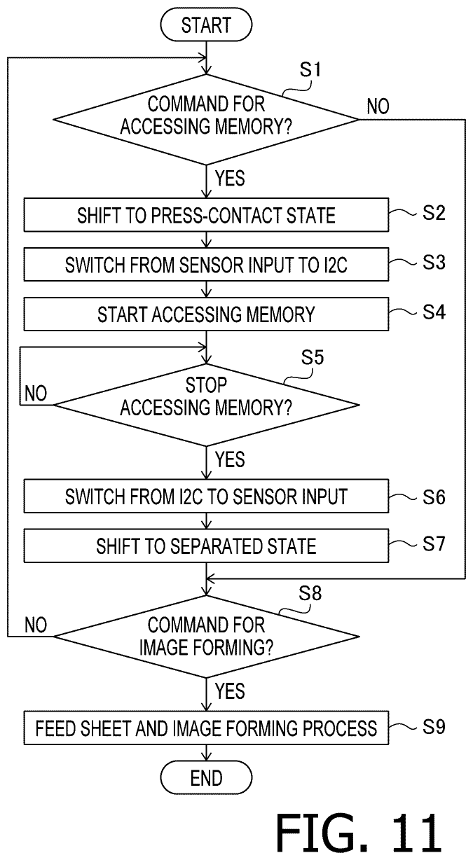

Next, among a plurality of controlling processes to be executed by the ASIC 210 in the printer 1 configured as above, a printing process for forming an image on a sheet S will be described with reference to FIG. 11. In the first embodiment, an example, in which the ASIC 210 accesses the memory 163 in the fuser 9 in the state before an instruction to form an image on the sheet S is received, will be described. FIG. 11 is a flowchart illustrating specifically a printing process, as a part of a main process executed after the printer 1 is powered on. The printing process is executed for forming an image on a sheet S. Steps (S1-S9) illustrated in the flowchart shown in FIG. 11 are written in the memory in the printer 1 and are executed by the ASIC 210.

First, in S1, the ASIC 210 determines whether an access command to access the memory 163 in the fuser 9 is input. The access command to the memory 163 may be executed, for example, immediately after the printer 1 is powered on, or immediately after the fuser 9 is attached to the main body 2 of the printer 1, such as after replacement of the fuser 9.

If the ASIC 210 determines that an access command to the memory 163 in the fuser 9 is input (S1: YES), the ASIC 210 proceeds to S2. On the other hand, if the ASIC 210 determines that no access command to the memory 163 in the fuser 9 is input (S1: NO), the ASIC 210 proceeds to S8.

In S2, the ASIC 210 drives the main motor 201A and turns an electromagnetic clutch on to drive the press-contact/separation assembly 900 in the fuser 9 described above, particularly by moving the pressure roller 92 with respect to the heat roller 91, thereby shifting from the separated state where the heat roller 91 and the pressure roller 92 are separated to the press-contact state where the heat roller 91 and the pressure roller 92 are pressed against each other (FIG. 6). The ASIC 210 receives a detection signal from the nip detection sensor SE3. Note that, in the present embodiment, the heat roller 91 and the pressure roller 92 are initially in the separated state.

Thereafter, in S3, the ASIC 210 switches the function of the relevant pin from input of the sensor information to I2C. While the function of the pin is switched to I2C, the ASIC 210 is unable to receive detection signals from the nip detection sensor SE3 or the discharge sensor SE4.

Next, in S4, the ASIC 210 starts accessing the memory 163 in the fuser 9. Specifically, a clock signal for synchronization is transmitted from the ASIC 210 to the memory 163 via the first controller terminal 255, the first main-body common terminal 261 of the main-body connector 150, the first fuser common terminal 260 in the fuser connector 160, and the first common terminal 253. While synchronizing based on the clock signal, the ASIC 210 reads data in the memory 163, and a data signal is transmitted from the memory 163 to the ASIC 210 via the second common terminal 254, the second fuser common terminal 262 in the fuser connector 160, the second main-body common terminal 263 in the main-body connector 150, and the second controller terminal 256. In S4, the press-contact/separation assembly 900 is in the press-contact state; therefore, the clock signal may be output by toggling the internal switch 257 on and off repeatedly (FIG. 10). Moreover, in S4, the memory 163 is accessed in the state before the instruction to the process unit 4 to form the image on the sheet S is received, when detecting of the status of the fuser 9 is not required generally. Therefore, even if communication of the detection signals from the nip detection sensor SE3 or the discharge sensor SE4 is temporarily stopped and replaced with communication of the clock signal and the data signal with the memory 163, the replacement may not generally cause a problem. Optionally, transmission of the clock signal and communication of the data signal may be performed simultaneously, or one may be performed prior to the other.

The information to be read from the memory 163 in S4 may include, for example, serial information of the fuser 9, and the lifespan of the fuser 9 including a cumulative count of times for the fuser 9 used in the past or a remaining count of times for the fuser 9 to be used in the future. The information read from the memory 163 may be used to verify whether the fuser 9 is compatible with the printer 1 or for guidance to timing of replacement.

Thereafter, in S5, the ASIC 210 determines whether the ASIC 210 is to stop accessing the memory 163, i.e., whether reading of the necessary information is completed.

If the ASIC 210 determines that the ASIC 210 is to stop accessing the memory 163 (S5: YES), the ASIC 210 proceeds to S6. On the other hand, if the ASIC 210 determines that the ASIC 210 is not to stop accessing the memory 163 (S5: NO), the ASIC 210 continues accessing the memory 163.

In S6, the ASIC 210 switches the function of the relevant pin from I2C back to input of the sensor information. Accordingly, the ASIC 210 is enabled to receive detection signals from the nip detection sensor SE3 and the discharge sensor SE4 and may detect the status of the fuser 9 later in a state where detection of the status of the fuser 9 is required.

Next, in S7, the ASIC 210 drives the main motor 201A and turns the electromagnetic clutch off to actuate the press-contact/separation assembly 900 in the fuser 9. Specifically, the pressure roller 92 is moved apart from the heat roller 91, thereby shifting from the press-contact state, in which the heat roller 91 and the pressure roller 92 are pressed against each other, to the separated state, in which the heat roller 91 and the pressure roller 92 are separated (see FIG. 6).

Thereafter, in S8, the ASIC 210 determines whether a print command has been input. Such a print command may be transmitted along with image data from an external device such as a PC via a wired or wireless communication using a network interface in the printer 1. Optionally, the printing process may rather be started in response to receiving of an execution command for forming an image through a user interface in the printer 1.

If the ASIC 210 determines that a print command is received (S8: YES), the ASIC 210 executes an image forming process (S9). Specifically, in the image forming process, the ASIC 210 drives the process unit 4 and the main motor 201A and controls the heater 93 based on the signals from the fuser temperature sensors TH1, TH2. Thereafter, the ASIC 210 operates the press-contact/separation assembly 900 to shift from the separated state to the press-contact state, the conveyer 3 to pick up the sheet S from the feeder tray 13 and convey in the first conveyer path 25, and after the leading edge of the sheet S is detected by the post-registration sensor 46, start forming an image on the sheet S. The image data to be printed may be received along with the print command from, for example, an external device such as a PC via the network interface. Based on the image data, the surfaces of the photosensitive drums 61 are exposed to light from a laser unit, and electrostatic latent images are formed thereon. The developing rollers 71 each supply toner to the electrostatic latent image formed on the surface of the corresponding photosensitive drum 61, thereby forming a toner image on the surfaces of the photosensitive drums 61. The transfer rollers 84 convey the sheet S in cooperation with the photosensitive drums 61, thereby transferring the toner images formed on the surfaces of the photosensitive drums 61 to the sheet S passing through the nips between the transfer rollers 84 and the photosensitive drums 61. As such, the image is formed on the sheet S. Thereafter, the toner image formed on the sheet S by the process unit 4 is fixed to the sheet S using the fuser 9. When the discharge sensor SE4 detects the leading edge of the sheet S passing through the nip position between the heat roller 91 and the pressure roller 92 in the fuser 9, the first conveyer roller 36, the second conveyer roller 37, and the first switchback roller 38 are driven forward to convey the sheet S in the first conveyer path 25 in the conveying direction. Discharging of the sheet S onto the discharge tray 22 completes the image forming process.

On the other hand, when the ASIC 210 determines that the print command is not received (S8: NO), the process returns to S1.

As described above, the fuser 9 according to the first embodiment is detachably attachable to the printer 1 that may form an image on the sheet S, and includes the heat roller 91 that may heat the sheet S, a pressure roller 92 that may nip the sheet S in cooperation with the heat roller 91, the fuser temperature sensors TH1, TH2 that may detect the temperatures of the heat roller 91, the nip detection sensor SE3 and the discharge sensor SE4 that may detect the status of the fuser 9, the fuser connector 160, connected to the main-body connector 150 in the printer 1 when the fuser 9 is attached to the main body 2 of the printer 1, the temperature sensor output terminals 251, 252 connected to the fuser connector 160, and the relay board 161, to which the fuser temperature sensors TH1, TH2, the nip detection sensor SE3, and the discharge sensor SE4 are connected. The relay board 161 relays the temperature detection signals from the fuser temperature sensors TH1, TH2 to the main body 2 of the printer 1 via the temperature sensor output terminals 251, 252, and relays the detection signal from the nip detection sensor SE3 and the clock signal from the memory 163 to the main body 2 of the printer 1 via the first common terminal 253 and the first fuser common terminal 260. Therefore, while the fuser 9 has the memory 163, increase in the number of terminals in the fuser connector 160 that connects the fuser 9 to the main body 2 of the printer 1 may be avoided. Moreover, the relay board 161 relays the detection signal from the discharge sensor SE4 to the main body 2 of the printer 1 and the data signal between the memory 163 and the main body 2 of the printer 1 via the second common terminal 254. Therefore, again, while the fuser 9 has the memory 163, increase in the number of terminals in the fuser connector that connects the fuser 9 to the main body 2 of the printer 1 may be avoided.

The relay board 161 includes the first line L3, one end of which is connected to the first common terminal 253, and the first memory connection line L1, one end of which is connected to the memory 163. The other end of the first line L3 is connected to the nip detection sensor SE3, and the other end of the first memory connection line L1 is connected to the first line L3. As such, the line for communication of the detection signal from the nip detection sensor SE3 and the line for accessing the memory 163 may be shared.

Further, the relay board 161 includes the second line L4, one end of which is connected to the second common terminal 254, and the second memory connection line L2, one end of which is connected to the memory 163. The other end of the second line L4 is connected to the discharge sensor SE4, and the other end of the second memory connection line L2 is connected to the second line L4. As such, the line for communication of the detection signal from the discharge sensor SE4 and the line for accessing the memory 163 may be shared.

Furthermore, the relay board 161 includes the ground portion GND. The nip detection sensor SE3 includes the phototransistor Tr1, which is connected to the other end of the first line L3 and may switch connection or disconnection between the ground portion GND and the first common terminal 253 according to the detection result indicating the status of the fuser 9.

The relay board 161 outputs the detection signal from the nip detection sensor SE3 through the first common terminal 253 according to the connection or the disconnection between the ground portion GND and the first common terminal 253 switched by the phototransistor Tr1. In the state where the ground portion GND and the first common terminal 253 are disconnected by the phototransistor Tr1, the relay board 161 communicates with the memory 163 and the ASIC 210 to transmit the clock signal to the memory 163 via the first common terminal 253. Therefore, in particular, when the phototransistor Tr1 is off, the clock signal may be transmitted to the memory 163.

The printer 1 includes the main-body connector 150 connectable with the fuser connector 160, and the main board 200 including the ASIC 210 connected to the main-body connector 150. The ASIC 210 is capable of receiving the detection signal from the nip detection sensor SE3 via the first common terminal 253, the first fuser common terminal 260, and the first main-body common terminal 261, and may transmit the clock signal to the memory 163 via the first common terminal 253, the fuser connector 160, and the main-body connector 150. Accordingly, compared to the conventional configuration, the number of terminals in the fuser connector that connects the fuser 9 and the main body 2 of the printer 1 may be reduced.

The relay board 161 in the fuser 9 includes the first line L3, one end of which is connected to the first common terminal 253, the first memory connection line L1, one end of which is connected to the memory 163, and the ground portion GND. The nip detection sensor SE3 includes the phototransistor Tr1, which is connected to the other end of the first line L3 and may switch connection or disconnection between the ground portion GND and the first common terminal 253 according to the detection result indicating the status of the fuser 9. The ASIC 210 includes the first controller terminal 255, which is connectable with the first common terminal 253 via the fuser connector 160 and the main-body connector 150. The ASIC 210 is, in the state where detection of the status of the fuser 9 is required, enabled to detect the status of the fuser 9 based on the voltage input to the first controller terminal 255 depending on the switched state of the phototransistor Tr1 in the nip detection sensor SE3. On the other hand, in the state where detection of the status of the fuser 9 is not required, the ASIC 210 is enabled to transmit the clock signal to the memory 163 through the first controller terminal 255. Accordingly, the ASIC 210 is enabled to detect the status of the fuser 9 based on the output from the nip detection sensor SE3 when necessary, but when detection of the status of the fuser 9 is not required, the ASIC 210 may access the memory 163 using the same terminal as the nip detection sensor SE3.

Furthermore, in the state where detection of the status of the fuser 9 is not required, the ASIC 210 outputs the clock signal to the memory 163 via the first main-body common terminal 261, the first fuser common terminal 260, and the first common terminal 253. Therefore, compared to conventional configurations, the number of connector terminals connecting the fuser 9 and the main body 2 of the printer 1 may be reduced.

Moreover, in the state where detection of the status of the fuser 9 is not required, the ASIC 210 receives the data signal for reading data in the memory 163 via the second common terminal 254, the second fuser common terminal 262, and the second main-body common terminal 263, and the second controller terminal 256. Therefore, compared to conventional configurations, the number of connector terminals connecting the fuser 9 and the main body 2 of the printer 1 may be reduced.

In particular, the same connector terminal may be used as the shared connector terminal for communication of the detection signal from the discharge sensor SE4, which may detect the sheet S passed through the nip position between the heat roller 91 and the pressure roller 92, and for acceding the memory 163.

Moreover, the ASIC 210 includes the ground portion GND connected to the first controller terminal 255, and the internal switch 257 that may switch connection and disconnection between the first controller terminal 255 and the ground portion GND. When the press-contact/separation assembly 900 is in the press-contact state, in other words, when the voltage of 3.3V is being input to the first controller terminal 255 of the ASIC 210, by turning the internal switch 257 of the ASIC 210 on and off alternately, connection and disconnection between the first controller terminal 255 and the ground portion GND are repeatedly switched. Accordingly, the high signal of 3.3V and the low signals of 0V are repeatedly output from the ASIC 210 to the CLK terminal of the memory 163, enabling the output of the clock signal.

Moreover, the state where detection of the status of the fuser is not required is the state before receiving an instruction to the process unit 4 to form an image on the sheet S. In this state, when an instruction to read data from the memory 163 is received, the clock signal is transmitted through the first controller terminal 255, and the data signal is received through the second controller terminal 256. As such, in the state where detection of the status of the fuser 9 is required, the status of the fuser 9 may be detected based on the outputs from the nip detection sensor SE3 and the discharge sensor SE4; on the other hand, in the state where detection of the status of the fuser 9 is not required, the ASIC 210 is enabled to access the memory 163.

### Second Embodiment

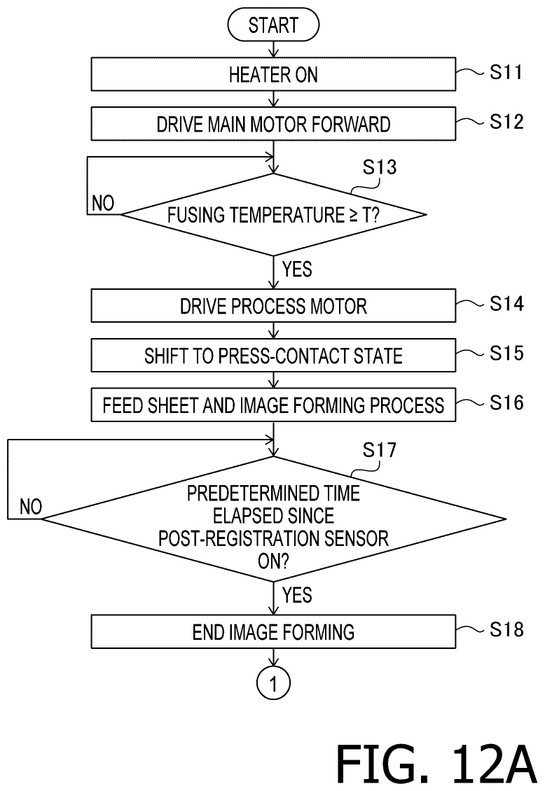

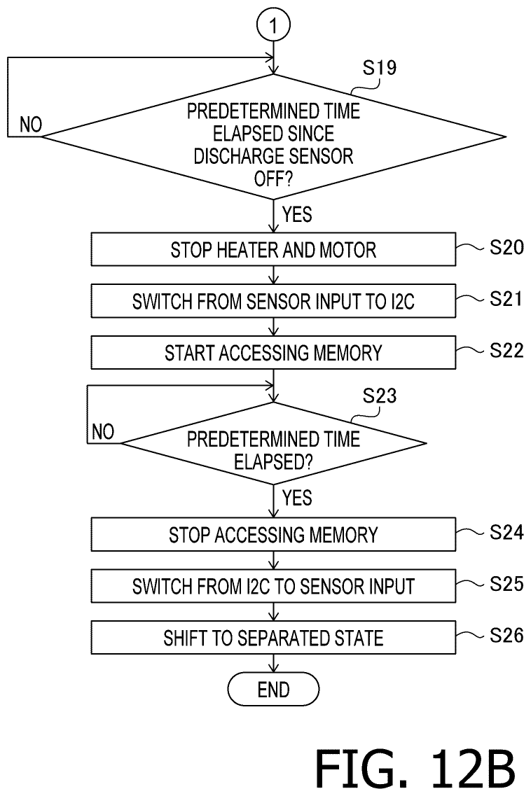

Next, a printer and a fuser according to the second embodiment of the present disclosure will be described with reference to FIGS. 12A-12B. In the following description, items that are in the same configuration as those in the printer 1 and the fuser 9 described in the first embodiment and shown in FIGS. 1 through 11 will be referred to by the same or corresponding reference signs.

The overall configurations of the printer 1 and the fuser 9 according to the second embodiment are substantially the same as those of the printer 1 and the fuser 9 of the first embodiment. Moreover, controlling processes in the second embodiment are substantially the same as those in the printer 1 and the fuser 9 of the first embodiment except for the timing when the ASIC 210 accesses the memory 163 in the printing process (see FIG. 11).

Hereinbelow, among the controlling processes to be executed by the ASIC 210 in the printer 1 of the second embodiment, particularly a printing process for forming an image on a sheet S will be described with reference to FIGS. 12A-12B. In the second embodiment, an example, in which the ASIC 210 accesses the memory 163 in the fuser 9 after completion of forming an image on the sheet S, will be described. FIGS. 12A-12B are a flowchart illustrating specifically a printing process, as a part of a main process executed after the printer 1 is powered on. The printing process is executed after a print command is received. Such a print command may be transmitted along with image data from an external device such as a PC via a wired or wireless communication using a network interface in the printer 1. Optionally, the printing process may rather be started in response to receiving of an execution command for forming an image through a user interface in the printer 1. Steps (S11-S26) illustrated in the flowchart shown in FIGS. 12A-12B are written in the memory in the printer 1 and are executed by the ASIC 210.

First, in S11, the ASIC 210 turns the heater 93 on and controls the heater 93 so that the temperature of the heat roller 91 reaches a target temperature, while monitoring the temperatures detected by the fuser temperature sensors TH1, TH2.

Next, in S12, the ASIC 210 drives the main motor 201A in the forward direction. As the main motor 201A is driven forward, output of the main motor 201A is transmitted to the pickup roller 33, the separation roller 34, the registration roller 35, the pressure roller 92, the first conveyer roller 36, the second conveyer roller 37, and first switchback roller 38 as driving forces. Among these rollers, however, the registration roller 35 is controlled not to start rotating simultaneously with the other rollers; instead, the timing to start rotating the registration roller 35 is determined based on the timing when the leading edge of the sheet S is detected by the pre-registration sensor 45, where the leading edge of the sheet S is aligned with a correct direction. The rollers 33, 34, 35, 92, 36, 37, 38 rotate to convey the sheet S in the conveying direction.

Next, in S13, the ASIC 210 determines, based on the temperatures detected by the fuser temperature sensors TH1, TH2, whether temperature of the heat roller 91 has reached the target temperature T.

If the ASIC 210 determines that temperature of the heat roller 91 has reached the target temperature T (S13: YES), the ASIC 210 drives a process motor (not shown) (S14). Accordingly, the photosensitive drums 61 and the developing rollers 71 in the process unit 4 rotate. If the ASIC 210 determines that the temperature of the heat roller 91 has not reached the target temperature T (S13: NO), the ASIC 210 awaits.

Next, in S15, the ASIC 210 drives the main motor 201A and turns the electromagnetic clutch on to drive the press-contact/separation assembly 900 in the fuser 9 described above, particularly by moving the pressure roller 92 with respect to the heat roller 91, thereby shifting from the separated state where the heat roller 91 and the pressure roller 92 are separated to the press-contact state where the heat roller 91 and the pressure roller 92 are pressed against each other (FIG. 6). Note that, in the present embodiment, the heat roller 91 and the pressure roller 92 are initially in the separated state.

Thereafter, in S16, the ASIC 210 executes the image forming process. Specifically, in the image forming process, the ASIC 210 operates the conveyer 3 to pick up the sheet S from the feeder tray 13 and convey in the first conveyer path 25, and after the leading edge of the sheet S is detected by the post-registration sensor 46, start forming an image on the sheet S. The image data to be printed may be received along with the print command from, for example, an external device such as a PC via the network interface. Based on the image data, the surfaces of the photosensitive drums 61 are exposed to light from a laser unit, and electrostatic latent images are formed thereon. The developing rollers 71 each supply toner to the electrostatic latent image formed on the surface of the corresponding photosensitive drum 61, thereby forming a toner image on the surfaces of the photosensitive drums 61. The transfer rollers 84 convey the sheet S in cooperation with the photosensitive drums 61, thereby transferring the toner images formed on the surfaces of the photosensitive drums 61 to the sheet S passing through the nips between the transfer rollers 84 and the photosensitive drums 61. As such, the image is formed on the sheet S. Thereafter, the toner image formed on the sheet S by the process unit 4 is fixed to the sheet S using the fuser 9. When the discharge sensor SE4 detects the leading edge of the sheet S passing through the nip position between the heat roller 91 and the pressure roller 92 in the fuser 9, the first conveyer roller 36, the second conveyer roller 37, and the first switchback roller 38 are driven forward to convey the sheet S in the first conveyer path 25 in the conveying direction. Discharging of the sheet S onto the discharge tray 22 completes the image forming process. Finally, the sheet S is discharged onto the discharge tray 22.

Next, in S17, the ASIC 210 determines whether a predetermined length of time has elapsed after forming of the image started in S16 and since the post-registration sensor 46 detected the leading edge of the sheet S. The predetermined length of time as the criterion to determine in S17 corresponds to a length of time required for the sheet S to pass entirely through the process unit 4 after the post-registration sensor 46 detected the leading edge of the sheet S.

If the ASIC 210 determines that the predetermined length of time has elapsed since the post-registration sensor 46 detected the leading edge of the sheet S (S17: YES), the image has been presumably formed completely by the process unit 4. Therefore, the ASIC 210 stops driving the process motor, which ends the image forming process (S18). On the other hand, if the ASIC 210 determines that the predetermined length of time has not elapsed since the post-registration sensor 46 detected the leading edge of the sheet S (S17: NO), the process unit 4 continues forming the image on the sheet S.

Next, in S19, the ASIC 210 determines whether a predetermined length of time has elapsed since the discharge sensor SE4 switched signals from on to off, in other words, since a trailing edge of the sheet S passed through the nip position between the heat roller 91 and the pressure roller 92. The predetermined length of time as the criterion to determine in S19 corresponds to a length of time required for the sheet S to be entirely discharged onto the discharge tray 22 after the discharge sensor SE4 detected the trailing edge of the sheet S passing thereby.

If the ASIC 210 determines that the predetermined length of time has elapsed since the discharge sensor SE4 switched signals from on to off (S19: YES), the ASIC 210 stops driving the heater 93 and the main motor 201A (S20). In the meantime, the press-contact/separation assembly 900 is not driven to shift to the separated state. On the other hand, if the ASIC 210 determines that the predetermined length of time has not yet elapsed since the discharge sensor SE4 switched signals from on to off (S19: NO), the sheet S with the image formed thereon is conveyed continuously.

Thereafter, in S21, the ASIC 210 switches the function of the relevant pin from sensor information input to I2C, in accordance with the access command to the memory 163 in the fuser 9. Optionally, the access command to the memory 163 in the fuser 9 may be executed every time forming of the image on the sheet S is completed, or may be executed only under a specific condition, such as every time when forming of images on 10 (ten) sheets is completed. The processes in S21-S25 may be performed only when the access command to the memory 163 in the fuser 9 is input.

Next, in S22, the ASIC 210 starts accessing the memory 163 in the fuser 9. Specifically, a clock signal for synchronization is transmitted from the ASIC 210 to the memory 163 via the first controller terminal 255, the first main-body common terminal 261 of the main-body connector 150, the first fuser common terminal 260 in the fuser connector 160, and the first common terminal 253. While synchronizing based on the clock signal, the ASIC 210 reads data in the memory 163, and a data signal is transmitted from the memory 163 to the ASIC 210 via the second common terminal 254, the second fuser common terminal 262 in the fuser connector 160, the second main-body common terminal 263 in the main-body connector 150, and the second controller terminal 256. In S22, the press-contact/separation assembly 900 is in the press-contact state; therefore, the clock signal may be output by toggling the internal switch 257 on and off repeatedly (FIG. 10). Moreover, in S22, the memory 163 is accessed in the state where the process unit 4 completed forming the image on the sheet S, when detecting of the status of the fuser 9 is generally not necessary. Therefore, even if communication of the detection signals with the nip detection sensor SE3 or the discharge sensor SE4 is temporarily stopped and replaced with communication of the clock signal and the data signal with the memory 163, the replacement generally may not cause a problem. Optionally, transmission of the clock signal and communication of the data signal may be performed simultaneously, or one may be performed prior to the other.

The information to be read from the memory 163 in S22 may include, for example, the lifespan of the fuser 9 including a cumulative count of times for the fuser 9 used in the past or a remaining count of times for the fuser 9 to be used in the future. Furthermore, in S22, the ASIC 210 updates the information concerning the lifespan of the fuser 9 by, for example, incrementing the count of pages printed in the past or decrementing the remaining count of times for the fuser 9 to be used in the future. For updating the lifetime information, the ASIC 210 transmits data signal to the memory 163.

In S23, the ASIC 210 determines whether a predetermined length of time has elapsed since the ASIC 210 started accessing the memory 163 in the fuser 9, in other words, whether time required for reading the necessary information or for updating the data has elapsed.

If the ASIC 210 determines that the predetermined length of time has elapsed since the ASIC 210 started accessing the memory 163 in the fuser 9 (S23: YES), the ASIC 210 stops accessing the memory 163 (S24). On the other hand, if the ASIC 210 determines that the predetermined length of time has not yet elapsed since the ASIC 210 started accessing the memory 163 in the fuser 9 (S23: NO), the ASIC 210 continues accessing the memory 163.

Next, in S25, the ASIC 210 switches the function of the relevant pin from I2C back to input of the sensor information. Accordingly, the ASIC 210 is enabled to receive detection signals from the nip detection sensor SE3 and the discharge sensor SE4 and may detect the status of the fuser 9 later in a state where detection of the status of the fuser 9 is required.

Next, in S26, the ASIC 210 drives the main motor 201A and turns the electromagnetic clutch off to actuate the press-contact/separation assembly 900 in the fuser 9. Specifically, the pressure roller 92 is moved apart from the heat roller 91, thereby shifting from the press-contact state, in which the heat roller 91 and the pressure roller 92 are pressed against each other, to the separated state, in which the heat roller 91 and the pressure roller 92 are separated (see FIG. 6). Thereafter, the ASIC 210 stops the main motor 201A.

As described in detail above, in the fuser 9 according to the second embodiment, the state after completion of forming an image on the sheet S is defined as the state where detection of the status of the fuser 9 is not required. In response to the instruction to read data from the memory 163, the ASIC 210 transmits the clock signal through the first controller terminal 255 and receives the data signal through the second controller terminal 256. Therefore, in the state where detection of the status of the fuser 9 is required, the status of the fuser 9 may be detected based on the outputs from the nip detection sensor SE3 and the discharge sensor SE4; on the other hand, in the state where detection of the status of the fuser 9 is not required, the ASIC 210 is enabled to access the memory 163.

### Third Embodiment

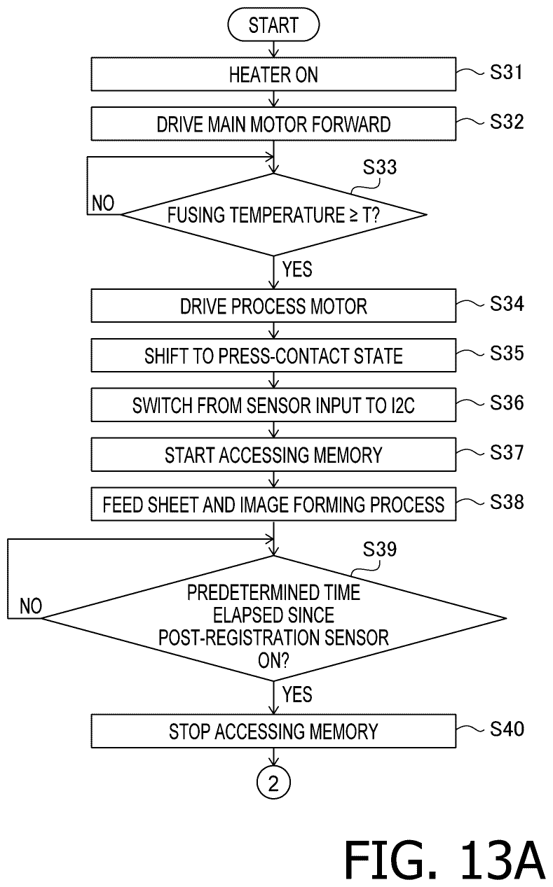

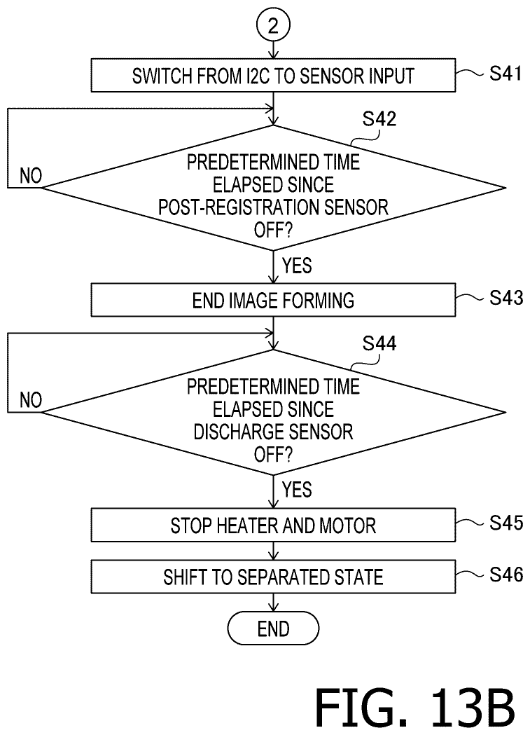

Next, a printer and a fuser according to the third embodiment of the present disclosure will be described with reference to FIGS. 13A-13B. In the following description, items that are in the same configuration as those in the printer 1 and the fuser 9 described in the first embodiment and shown in FIGS. 1 through 11 will be referred to by the same or corresponding reference signs.

The overall configurations of the printer 1 and the fuser 9 according to the third embodiment are substantially the same as those of the printer 1 and the fuser 9 of the first embodiment. Moreover, controlling processes in the third embodiment are substantially the same as those in the printer 1 and the fuser 9 of the first embodiment except for the timing when the ASIC 210 accesses the memory 163 in the printing process (see FIG. 11).

Hereinbelow, among the controlling processes to be executed by the ASIC 210 in the printer 1 of the third embodiment, particularly a printing process for forming an image on a sheet S will be described with reference to FIGS. 13A-13B. In the third embodiment, an example, in which the ASIC 210 accesses the memory 163 in the fuser 9 while an image is being formed on the sheet S, will be described. FIGS. 13A-13B are a flowchart illustrating specifically a printing process, as a part of a main process executed after the printer 1 is powered on. The printing process is executed after a print command is received. Such a print command may be transmitted along with image data from an external device such as a PC via a wired or wireless communication using a network interface in the printer 1. Optionally, the printing process may rather be started in response to receiving of an execution command for forming an image through a user interface in the printer 1. Steps (S31-S46) illustrated in the flowchart shown in FIGS. 13A-13B are written in the memory in the printer 1 and are executed by the ASIC 210.

First, in S11, the ASIC 210 turns the heater 93 on and controls the heater 93 so that the temperature of the heat roller 91 reaches a target temperature, while monitoring the temperatures detected by the fuser temperature sensors TH1, TH2.

Next, in S32, the ASIC 210 drives the main motor 201A in the forward direction. As the main motor 201A is driven forward, output of the main motor 201A is transmitted to the pickup roller 33, the separation roller 34, the registration roller 35, the pressure roller 92, the first conveyer roller 36, the second conveyer roller 37, and first switchback roller 38 as driving forces. Among these rollers, however, the registration roller 35 is controlled not to start rotating simultaneously with the other rollers; instead, the timing to start rotating the registration roller 35 is determined based on the timing when the leading edge of the sheet S is detected by the pre-registration sensor 45, where the leading edge of the sheet S is aligned with a correct direction. The rollers 33, 34, 35, 92, 36, 37, 38 rotate to convey the sheet S in the conveying direction.

Next, in S33, the ASIC 210 determines, based on the temperatures detected by the fuser temperature sensors TH1, TH2, whether temperature of the heat roller 91 has reached the target temperature T.

If the ASIC 210 determines that temperature of the heat roller 91 has reached the target temperature T (S33: YES), the ASIC 210 drives the process motor (S34). Accordingly, the photosensitive drums 61 and the developing rollers 71 in the process unit 4 rotate. If the ASIC 210 determines that the temperature of the heat roller 91 has not reached the target temperature T (S33: NO), the ASIC 210 awaits.

Next, in step S35, the ASIC 210 drives the main motor 201A and turns the electromagnetic clutch on to drive the press-contact/separation assembly 900 in the fuser 9 described above, particularly by moving the pressure roller 92 toward the heat roller 91, thereby shifting from the separated state where the heat roller 91 and the pressure roller 92 are apart to the press-contact state where the heat roller 91 and the pressure roller 92 are pressed against each other (FIG. 6). Note that, in the present embodiment, the heat roller 91 and the pressure roller 92 are initially in the separated state.

Thereafter, in S36, the ASIC 210 switches the function of the relevant pin from sensor information input to I2C, in accordance with the access command to the memory 163 in the fuser 9. Optionally, the access command to the memory 163 in the fuser 9 may be executed every time forming of the image on the sheet S is completed, it may be executed only under a specific condition, such as every time when forming of images on 10 (ten) sheets is completed. The processes in S36, S37, and S39-S41 may be performed only when the access command to the memory 163 in the fuser 9 is input.

Next, in S37, the ASIC 210 starts accessing the memory 163 in the fuser 9. Specifically, a clock signal for synchronization is transmitted from the ASIC 210 to the memory 163 via the first controller terminal 255, the first main-body common terminal 261 of the main-body connector 150, the first fuser common terminal 260 in the fuser connector 160, and the first common terminal 253. While synchronizing based on the clock signal, the ASIC 210 reads data in the memory 163, and a data signal is transmitted from the memory 163 to the ASIC 210 via the second common terminal 254, the second fuser common terminal 262 in the fuser connector 160, the second main-body common terminal 263 in the main-body connector 150, and the second controller terminal 256. As such, the ASIC 210 is enabled to output the clock signal (FIG. 10). In S37, the memory 163 is accessed when the process unit 4 is forming the image on the sheet S but before the discharge sensor SE4 detects the sheet S, in other words, before the sheet S reaches the fuser 9; therefore, detecting of the status of the fuser 9 is generally not necessary. Therefore, even if communication of the detection signals with the nip detection sensor SE3 or the discharge sensor SE4 is temporarily stopped and replaced with communication of the clock signal and the data signal with the memory 163, the replacement may not generally cause a problem. Optionally, transmission of the clock signal and communication of the data signal may be performed simultaneously, or one may be performed prior to the other.

The information to be read from the memory 163 in S37 may include, for example, information concerning the setting parameters for the fuser 9. As such, the ASIC 210 is enabled to control the fuser 9 based on the information concerning the setting parameters read from the memory 163.

Next, in S38, the ASIC 210 executes the image forming process while accessing the memory 163 in parallel. Specifically, in the image forming process, the ASIC 210 operates the conveyer 3 to pick up the sheet S from the feeder tray 13 and convey in the first conveyer path 25, and after the leading edge of the sheet S is detected by the post-registration sensor 46, start forming an image on the sheet S. The image data to be printed may be received along with the print command from, for example, an external device such as a PC via the network interface. Based on the image data, the surfaces of the photosensitive drums 61 are exposed to light from the laser unit, and electrostatic latent images are formed thereon. The developing rollers 71 each supply toner to the electrostatic latent image formed on the surface of the corresponding photosensitive drum 61, thereby forming a toner image on the surfaces of the photosensitive drums 61. The transfer rollers 84 convey the sheet S in cooperation with the photosensitive drums 61, thereby transferring the toner images formed on the surfaces of the photosensitive drums 61 to the sheet S passing through the nips between the transfer rollers 84 and the photosensitive drums 61. As such, the image is formed on the sheet S. Thereafter, the toner image formed on the sheet S by the process unit 4 is fixed to the sheet S using the fuser 9. When the discharge sensor SE4 detects the leading edge of the sheet S passing through the nip position between the heat roller 91 and the pressure roller 92 in the fuser 9, the first conveyer roller 36, the second conveyer roller 37, and the first switchback roller 38 are driven forward to convey the sheet S in the first conveyer path 25 in the conveying direction. Finally, the sheet S is discharged onto the discharge tray 22. Finally, the sheet S is discharged onto the discharge tray 22.

Next, in S39, the ASIC 210 determines whether a predetermined length of time has elapsed after forming of the image started in S38 and since the post-registration sensor 46 detected the leading edge of the sheet S. The predetermined length of time as the criterion to determine in step S39 is shorter than the length of time required for the sheet S to pass entirely through the process unit 4 and the leading edge of the sheet S to reach the fuser 9, but is longer than a length of time required for the ASIC 210 to read the necessary information and update the data.

If the ASIC 210 determines that the predetermined length of time has elapsed since the post-registration sensor 46 detected the leading edge of the sheet S (S39: YES), the ASIC 210 stops accessing the memory 163 (S40). On the other hand, if the ASIC 210 determines that the predetermined length of time has not yet elapsed since the post-registration sensor 46 detected the leading edge of the sheet S (S39: NO), the ASIC 210 continues accessing the memory 163.

Next, in step S41, the ASIC 210 switches the function of the relevant pin from I2C back to input of the sensor information. Accordingly, the ASIC 210 is enabled to receive detection signals from the nip detection sensor SE3 and the discharge sensor SE4 and may detect the status of the fuser 9 later in a state where detection of the status of the fuser 9 is required.

Next, in S42, the ASIC 210 determines whether a predetermined length of time has elapsed after forming of the image started in S38 and since the post-registration sensor 46 detected the trailing edge of the sheet S passing through. The predetermined length of time as the criterion to determine in S42 corresponds to a length of time required for the sheet S to pass entirely through the process unit 4 after the post-registration sensor 46 detected the trailing edge of the sheet S passing thereby.

If the ASIC 210 determines that the predetermined length of time has elapsed since the post-registration sensor 46 detected the trailing edge of the sheet S (S42: YES), the image has been presumably formed completely by the process unit 4. Therefore, the ASIC 210 stops driving the process motor, which ends the image forming process (S43). On the other hand, if the ASIC 210 determines that the predetermined length of time has not elapsed since the post-registration sensor 46 detected the trailing edge of the sheet S (S42: NO), the process unit 4 continues forming the image on the sheet S.

Next, in S44, the ASIC 210 determines whether a predetermined length of time has elapsed since the discharge sensor SE4 switched signals from on to off, in other words, since the trailing edge of the sheet S passed through the nip position between the heat roller 91 and the pressure roller 92. The predetermined length of time as the criterion to determine in S44 corresponds to a length of time required for the sheet S to be discharged entirely onto the discharge tray 22 after the discharge sensor SE4 detected the trailing edge of the sheet S passing thereby.

If the ASIC 210 determines that the predetermined length of time has elapsed since the discharge sensor SE4 switched signals from on to off (S44: YES), the ASIC 210 stops driving the heater 93 and the main motor 201A (S45). On the other hand, if the ASIC 210 determines that the predetermined length of time has not yet elapsed since the discharge sensor SE4 switched signals from on to off (S44: NO), the sheet S with the image formed thereon is conveyed continuously.

Next, in S46, the ASIC 210 drives the main motor 201A and turns the electromagnetic clutch off to actuate the press-contact/separation assembly 900 in the fuser 9. Specifically, the pressure roller 92 is moved apart from the heat roller 91, thereby shifting from the press-contact state, in which the heat roller 91 and the pressure roller 92 are pressed against each other, to the separated state, in which the heat roller 91 and the pressure roller 92 are separated (see FIG. 6).

As described in detail above, in the fuser 9 according to the third embodiment, the state after the instruction for forming an image on a sheet S is received and the press-contact/separation assembly 900 shifted from the separated state to the press-contact state, and before the sheet S is detected by the discharge sensor SE4, is defined as the state where detection of the status of the fuser is required. In response to the instruction to read data from the memory 163, ASIC 210 transmits the clock signal through the first controller terminal 255 and receives the data signal through the second controller terminal 256. Therefore, in the state where detection of the status of the fuser 9 is required, the status of the fuser 9 may be detected using the nip detection sensor SE3 and the discharge sensor SE4. On the other hand, when detection of the status of the fuser is not required, the ASIC 210 is enabled to access the memory 163.

While the present disclosure described in conjunction with example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the disclosure, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential modifications according to aspects of the present disclosure are provided below.

For example, in the above embodiments, in order to reduce the number of terminals in the fuser connector 160 and the main-body connector 150, a common signal line is shared with communication of the detection signal with the nip detection sensor SE3 and communication of the clock signal with the memory 163, another common signal line is shared with communication of the detection signal with the nip detection sensor SE3 and communication of the clock signal with the memory 163, and another common signal line is shared with communication of the detection signal with the discharge sensor SE4 and communication of the data signal with the memory 163, on the relay board 161. However, solely either one of the detection signals from the nip detection sensor SE3 or the discharge sensor SE4 may share the signal line with the memory 163. For another example, a signal line may be shared with communication of the detection signal with the discharge sensor SE4 and communication of the clock signal with the memory 163, and a signal line may be shared with communication of the detection signal with the nip detection sensor SE3 and communication of the data signal with the memory 163.

For another example, the image forming apparatus may not necessarily be limited to the printer 1 but may be a copier, a facsimile machine, or a multifunction peripheral machine having a printing function and a scanning function.

What is claimed is:

1. A fuser detachably attachable to an image forming apparatus, the image forming apparatus being configured to form a toner image on a sheet, the fuser comprising:
a heating rotatable body configured to heat the sheet;
a heater configured to heat the heating rotatable body;
a pressing rotatable body configured to nip the sheet in cooperation with the heating rotatable body;
a detection sensor configured to detect a status of the fuser;
a fuser connector, through which the fuser is connected with the image forming apparatus when the fuser is attached to the image forming apparatus, the fuser connector including a fuser common terminal; and
a relay board including a common terminal connected to the fuser common terminal, and a memory, the relay board being connected with the detection sensor, the relay board being configured to relay a detection signal from the detection sensor to the image forming apparatus and a memory signal between the memory and the image forming apparatus via the common terminal and the fuser common terminal.

2. The fuser according to claim 1, wherein
the relay board includes a line, one end of which is connected to the common terminal, and a memory connection line, one end of which is connected to the memory,
the other end of the line is connected to the detection sensor, and
the other end of the memory connection line is connected to the line.

3. The fuser according to claim 2, wherein
the relay board includes a board ground portion,
the detection sensor includes a switching device, to which the other end of the line is connected, the switching device being configured to switch connection and disconnection between the board ground portion and the common terminal according to a detection result indicating the detected status of the fuser, and
the relay board is configured to:
output the detection signal through the common terminal depending on the connection or the disconnection between the board ground portion and the common terminal switched by the switching device; and
in a state where the board ground portion and the common terminal are disconnected by the switching device, communicate with the memory and the image forming apparatus for transmitting and receiving of the memory signal between the memory and the image forming apparatus via the common terminal.

4. The fuser according to claim 1, further comprising a temperature sensor configured to detect a temperature of the heating rotatable body, wherein
the relay board includes a temperature sensor output terminal connected to the fuser connector and to the temperature sensor, and
the relay board is configured to relay a temperature detection signal from the temperature sensor to the image forming apparatus via the temperature sensor output terminal.

5. An image forming apparatus, to which a fuser is detachably attached, the image forming apparatus being configured to form a toner image on a sheet, the fuser including:
a heating rotatable body configured to heat the sheet;
a heater configured to heat the heating rotatable body;
a pressing rotatable body configured to nip the sheet in cooperation with the heating rotatable body;
a first detection sensor configured to detect a status of the fuser;
a fuser connector, through which the fuser is connected with the image forming apparatus when the fuser is attached to the image forming apparatus, the fuser connector including a first fuser common terminal; and
a relay board including a first common terminal connected to the first fuser common terminal, and a memory, the relay board being connected with the first detection sensor, the relay board being configured to relay a first detection signal from the first detection sensor to the image forming apparatus and a first memory signal between the memory and the image forming apparatus via the first common terminal and the first fuser common terminal,
the image forming apparatus comprising:
a main-body connector connectable with the fuser connector, the main-body connector including a first main-body common terminal connectable with the first fuser common terminal; and
a control board including a controller connected with the main-body connector, the controller being configured to:
receive the first detection signal from the first detection sensor via the first common terminal, the first fuser common terminal, and the first main-body common terminal, and
communicate with the memory to transmit and receive the first memory signal to and from the memory via the first common terminal, the first fuser common terminal, and the first main-body common terminal.

6. The image forming apparatus according to claim 5, wherein
the relay board in the fuser includes a first line, one end of which is connected to the first common terminal, and a first memory connection line, one end of which is connected to the memory, and a board ground portion,
the first detection sensor in the fuser includes a first switching device, to which the other end of the first line is connected, the first switching device being configured to switch connection and disconnection between the board ground portion and the first common terminal according to a detection result indicating the detected status of the fuser,
the controller includes a first controller terminal connectable with the first common terminal via the first fuser common terminal and the first main-body common terminal, and
the controller is configured to, in a state where detection of the status of the fuser is required, detect the status of the fuser based on a voltage input to the first controller terminal depending on the connection or the disconnection between the board ground portion and the first common terminal switched by the first switching device; and in a state where detection of the status of the fuser is not required, communicate with the memory to transmit and receive the first memory signal to and from the memory via the first controller terminal.

7. The image forming apparatus according to claim 6, wherein
the first memory signal is a data signal for the controller to read data from the memory, and
the controller is configured to, in the state where detection of the status of the fuser is not required, receive the first memory signal from the memory via the first common terminal, the first fuser common terminal, the first main-body common terminal, and the first controller terminal.

8. The image forming apparatus according to claim 7, wherein the first detection sensor is a discharge sensor configured to detect whether the sheet has passed through a nip position between the heating rotatable body and the pressing rotatable body.

9. The image forming apparatus according to claim 6, wherein
the first memory signal is a clock signal output from the control board to the memory, and
the control board is configured to, in the state where detection of the status of the fuser is not required, output the first memory signal to the memory via the main-body connector, the first fuser common terminal, and the first main-body common terminal.

10. The image forming apparatus according to claim 9, wherein
the fuser includes a press-contact/separation assembly configured to switch a state of the heating rotatable body and the pressing rotatable body between a press-contact state, in which the heating rotatable body and the pressing rotatable body are pressed against each other, and a separated state, in which the heating rotatable body and the pressing rotatable body are separated,
the first detection sensor is a nip detection sensor configured to detect whether the press-contact/separation assembly is in the press-contact state or the separated state, the nip detection sensor being configured to switch connection and disconnection between the board ground portion and the first common terminal by operating the first switching device such that the board ground portion and the first common terminal are disconnected when the press-contact/separation assembly is in the press-contact state, and the board ground portion and the first common terminal are connected when the press-contact/separation assembly is in the separated state,
the controller includes an internal switch configured to switch connection and disconnection between a ground portion and the first controller terminal,
the control board includes a first power source connected with the first line, and
the controller is configured to:
in the state where detection of the status of the fuser is required, operate the internal switch to disconnect the ground portion and the first controller terminal from each other and detect whether the press-contact/separation assembly is in the press-contact state or the separated state based on the voltage input from the first power source to the first controller terminal; and
in the state where detection of the status of the fuser is not required, and when the press-contact/separation assembly is in the press-contact state, output the first memory signal to the memory by operating the internal switch to alternately connect and disconnect the first controller terminal and the ground portion repeatedly.

11. The image forming apparatus according to claim 10, further comprising a second detection sensor being a discharge sensor configured to detect whether the sheet has passed through a nip position between the heating rotatable body and the pressing rotatable body, wherein
the relay board includes a second common terminal connected to the fuser connector, a second line, one end of which is connected to the second common terminal, and a second memory connection line, one end of which is connected to the memory,
the relay board is configured to relay a second detection signal from the second detection sensor to the image forming apparatus and a second memory signal between the memory and the image forming apparatus via the second common terminal,
the second detection sensor includes a second switching device configured to switch connection and disconnection between the board ground portion and the second common terminal depending on whether the sheet has passed through the nip position,
the controller includes a second controller terminal,
the control board includes a second power source connected with the second line,
the second memory signal is a data signal for the controller to read data from the memory, and
the controller is configured to:
in the state where detection of the status of the fuser is required, detect whether the sheet has passed through the nip position based on the voltage input from the second power source to the second controller terminal; and
in the state where detection of the status of the fuser is not required, and when the press-contact/separation assembly is in the press-contact state, receive the second memory signal from the memory via the second common terminal, the fuser connector, the main-body connector, and the second controller terminal.

12. The image forming apparatus according to claim 11, further comprising an image forming device configured to form the toner image on the sheet, wherein
the controller is configured to, in the state where detection of the status of the fuser is not required and in a state before receiving an instruction to the image forming device to form the toner image on the sheet, in response to an instruction to read the data from the memory, transmit the first memory signal through the first controller terminal and receive the second memory signal through the second controller terminal.

13. The image forming apparatus according to claim 11, further comprising an image forming device configured to form the toner image on the sheet, wherein
the controller is configured to, in the state where detection of the status of the fuser is not required and in a state after completion of forming the image on the sheet, in response to an instruction to read the data from the memory, transmit the first memory signal through the first controller terminal and receive the second memory signal through the second controller terminal.

14. The image forming apparatus according to claim 11, further comprising an image forming device configured to form the toner image on the sheet, wherein
the controller is configured to, after receiving the instruction to the image forming device to form the toner image on the sheet and after the state of the press-contact/separation assembly is switched from the separated state to the press-contact state, but before the sheet is detected by the discharge sensor, transmit the first memory signal through the first controller terminal and receive the second memory signal through the second controller terminal.

15. The image forming apparatus according to claim 5, further comprising a temperature sensor configured to detect a temperature of the heating rotatable body, wherein
the relay board includes a temperature sensor output terminal connected to the fuser connector and to the temperature sensor, and
the relay board is configured to relay a temperature detection signal from the temperature sensor to the image forming apparatus via the temperature sensor output terminal.
